(19) United States
(12) Patent Application Publication
(10) Pub. No.: US 2017/0171534 A1
(43) Pub. Date: Jun. 15, 2017

(54) METHOD AND APPARATUS TO DISPLAY STEREOSCOPIC IMAGE IN 3D DISPLAY SYSTEM

(71) Applicant: SAMSUNG ELECTRONICS CO., LTD., Suwon-si (KR)

(72) Inventors: Mahesh KONDIPARTHI, Uttar Pradesh (IN); E N. SATHEESAN, Uttar Pradesh (IN)

(73) Assignee: SAMSUNG ELECTRONICS CO., LTD., Suwon-si (KR)

(21) Appl. No.: 15/349,247

(22) Filed: Nov. 11, 2016

(30) Foreign Application Priority Data
Nov. 12, 2015 (IN) 3700/DEL/2015

(51) Int. Cl. H04N 13/04; H04N 13/00

(52) U.S. Cl. CPC H04N 13/0429; H04N 13/0022; H04N 13/0452; H04N 13/0445; H04N 13/0468; H04N 2013/0081

(57) ABSTRACT

A method for display a stereoscopic image in a 3D display system is provided. The method includes generating at least one curvature depth map based on at least one virtual curvature value, generating at least one pair of stereoscopic images from frames of at least one content based on the at least one curvature depth map, and displaying or projecting the at least one pair of stereoscopic images on a display screen.

### CROSS-REFERENCE TO RELATED APPLICATION

This application claims priority to Indian patent Application No. 3700/DEL/2015, filed with the India Patent Office on Nov. 12, 2015, the entire disclosure of which is hereby incorporated by reference.

### TECHNICAL FIELD

The present disclosure relates to a method and an apparatus to display a stereoscopic image in a 3D display system.

### BACKGROUND

Majority of 3D display systems, such as high end televisions, come with a 3D mode in addition a regular 2D mode. The 3D mode provides realistic views by creating an illusion of depth. In the 3D mode, the system displays three-dimensional moving pictures by rendering offset images that need to be filtered separately to the left eye and the right eye. In one technique, the system instructs a pair of shutter glasses, also known as 3D glasses, to selectively close a left shutter or a right shutter of the 3D glasses to control which eye of the wearer of the 3D glasses receives the image being exhibited at the moment, thereby creating stereoscopic imaging.

One other technology that is gaining popularity is multi-view. Multi-view is the concept of sharing the same screen between multiple viewers either spatially or temporally. One of the techniques in which the temporal sharing of the screen can be achieved is shutter glasses. In this technique, for two viewer setup, the even frames are shown to the first viewer and the odd frames are shown to the second viewer. The concept of 3D and temporal Multi-view can be clubbed together, wherein each viewer sees unique content in 3D. This can be achieved by sharing video display frames either spatially and/or temporally.

Further, any television, including a 3D TV can be classified on the basis of type of its screen, such as a flat screen TV or a mechanically curved screen TV. Each class has its own advantages and disadvantages. TVs having a mechanically curved screen improve immersion as the sense of depth is enhanced with a wider field of view. Further, contrast is better as compared to flat screens as light coming from the screen falls at eyes more directly. Furthermore, content is displayed in a circular plane of focus, facilitating eyes to be more relaxed. The downside of mechanically curved screens is that it needs to be big. Further, it exaggerates reflections and limits viewing angles. In other words, a viewer needs to be in a sweet spot, i.e., at the centre to get the best view. Due these and other practical reasons, many viewers still prefer flat screen TVs.

To this end, there exist adjustable mechanical curved TVs, which can mechanically bend a flat screen using servo motors to achieve desired mechanical curvature. However, such systems lack dynamic adjustment of curvature as a manual input from the viewer is needed to pre-adjust the curvature. Further, this mechanical curvature is common for all viewers. Furthermore, such televisions are very complex and costly. There also exist head mounted stereoscopic 3D display devices, but only one person can view the content at a time. Further, the depth cannot be adjusted based on factors, such as user taste or media content. The physical display needs to be curved and there is no option for simultaneous horizontal and vertical curvature. There are techniques which utilize a constant depth correction to create stereo images with comfortable perceived depth. This constant depth correction is based on screen disparity, viewer's eye separation (E), and display viewing distance (Z). These techniques focus only on correcting depth based on the above mentioned parameters and do not provide the immersive experience by making the screen curved to surround the viewer. Further, depth mapping is done using trial and error methods to provide a comfortable viewing experience. Once the depth is corrected, then the depth is fixed.

To summarize, one set of prior arts relate to an adjustable mechanical curved display for projecting images. The variable curvature of screen is made possible by a driving mechanism arranged to move the screen from being substantially flat when the system is in the flat configuration to being curved along at least one dimension when the system is in the curved configuration. The screen may be curved in two dimensions as well in the curved configuration and preferably is shaped substantially like a spherical cap or segment. While this set of prior arts proposes an improvement in the user experience by mechanically adjusting the curvature of the screen, some of the obvious shortcomings with respect to the proposed invention are: the need for a bulky driving mechanism, the curvature needs to be set in advance before watching a program, tedious to change the curvature as it involves adjusting the projecting software to correct the curvature of projection, and mechanically change in the actual curvature of screen, etc.

Another set of prior arts relate to a head mounted stereoscopic 3-D display devices using the tunable focus liquid crystal micro-lens array to produce eye accommodation information. A liquid crystal display panel displays stereoscopic images and uses tunable liquid crystal micro-lens array to change the diopter of the display pixels to provide eye accommodation information. However, the entire system to display the image can be curved. This set of prior arts has the advantage of modifying the depth map to reduce the discomfort. However, the proposed screen curvature cannot be adjusted. This means that, once a device is manufactured, the user has to settle with the experience of the given curvature of the screen. Secondly, the head mounted device which restrict the experience to only one person at a time.

Another set of prior arts relate to rendering stereoscopic images and methods that can reduce discomfort caused by decoupling between eye accommodation and vergence. This is achieved by modifying the depth map of the two-dimensional image frame such that a range of depth values in the depth map that is associated the object of focus is redistributed toward a depth level of a display screen, and generating a virtual stereoscopic image frame based on the modified depth map and the two-dimensional image frame. This set of prior arts also focuses on adjusting the depth map to provide a better user experience. However, these prior arts do not focus on the immersive experience that a user gets if the display screen is curved. Further, multi-view feature is not there.

Another set of prior arts relate to user position based adjustment of display curvature, and showcases the same in a 3D display (lenticular-lens based system). In the presence of multiple-users, an average position is obtained to estimate curvature. However, all the viewers are forced to see a particular curvature. Further, there is no provision to showcase unique curvature for each viewer individually. Furthermore, such prior arts do not touch upon angle based curvature adjustment and depth map generation.

Another set of prior arts relate to lenticular lenses and concave-curved screens to create a convex-picture, but concave pictures are not covered. They are restricted only to convex pictures. Such prior arts may include image content, such human face, coke-tin, based curvature adjustment. However, they are silent on resolution based curvature adjustment. Further, this set of prior arts won't suite for dynamic changes in curvature, as the micro-lenses are designed for a particular curvature. While multi-view may be provided, but every user is compelled to view only one particular curvature. Further, such prior arts do not touch upon angle based curvature adjustment and depth map generation.

Another set of prior arts relate to adjusting the video-depth-map with a destination-depth map to create a tailored depth-map, tailored for video displays. Depictions show that the tailoring is done only for displays of different sizes. This set of prior arts address adapting the original depth map to a new depth map considering the actual size of the 3D viewing display. In short, they disclose warping of views to change source depth-map for adapting to a destination 3D-display. However, they are silent on adjusting the wrapping based on location viewers, content, resolution, user inputs, etc.

Another set of prior arts relate to adding depth to the L-R images to create a new depth map including the depth of the televisions. Hence, a cumulative depth map, which considers the depths involved in the curved TV will be generated. However, they are silent on dynamic adjustment of curvature because the curvature of the TV is fixed and won't change over time. Further, they do not touch upon multiple curvatures for individual viewers.

Accordingly, there is a scope of improvement in this area of technology despite of aforesaid teachings.

The above information is presented as background information only to assist with an understanding of the present disclosure. No determination has been made, and no assertion is made, as to whether any of the above might be applicable as prior art with regard to the present disclosure.

### SUMMARY

This summary is provided to introduce a selection of concepts in a simplified format that are further described in the detailed description of the invention. This summary is not intended to identify key or essential inventive concepts of the claimed subject matter, nor is it intended for determining the scope of the claimed subject matter.

Another aspect of the present disclosure is to provide a method and an apparatus for displaying a stereoscopic image in a 3D display system.

Another aspect of the present disclosure is to provide a method and apparatus for providing immersive visual experience in a 3D display system.

Another aspect of the present disclosure is to provide a method and an apparatus to dynamically realize experience of a curved screen in a flat screen television, and vice versa, for example, in order to preserve the “sweet spot” effect for everyone in case of multiple viewers.

The present disclosure overcomes the above mentioned deficiencies of the hard curved displays by providing specialized manipulation of content, which when viewed through binocular 3D system creates a visual illusion of the curved screen. The invention defines a metric for stereoscopic 3D image pair generation, wherein the depth map is calculated from the curvature to be visualized in a flat screen; thereby creating the desired curved screen illusion in a flat screen, and vice versa. In case of multiple viewers, the stereoscopic 3D image pair is generated for each viewer individually depending upon one or more parameters, such as position, distance, or movement of a viewer in any direction from a display screen. Other examples of such parameters include, but are not limited to resolution of the content, user preference/inputs, etc. The concept of multi-view is utilized such that each viewer can see a virtual curvature personalized for that viewer depending upon said one or more parameters. The idea is to provide a symmetrical curvature to every user irrespective of the position of the viewer with respect to the screen.

According to one general aspect of the present disclosure, a method for display a stereoscopic image in a 3D display system comprising: generating at least one curvature depth map based on at least one virtual curvature value to display; generating at least one pair of stereoscopic images from frames of at least one content based on the at least one curvature depth map; and displaying or projecting the at least one pair of stereoscopic images on a display screen.

According to one general aspect of the present disclosure, a 3D display apparatus (300) comprising: a display; a depth generation module configured to generate at least one curvature depth map based on at least one virtual curvature value; a stereoscopic image generation module configured to generate at least one pair of stereoscopic images from frames of at least one content based on the at least one curvature depth map; and a controller configured to apply the at least one virtual curvature value to the at least one pair of stereoscopic images, and control the display to display the at least one pair of stereoscopic images on a display screen.

According to one general aspect of the present disclosure, a binocular 3D vision system for visualizing curved 3D effect in a flat screen using, comprises: first means to generate depth map of the desired curvature; second means to add the object depth map of the video to the depth map resultant from first means; third means to extract stereoscopic 3D images from input video and the depth map obtained from second means, and fourth means to display and/or visualize binocular 3D of the stereoscopic image pairs in order to visualize the 3D curve on a flat screen, and vice versa.

The present disclosure also provides a method to simulate a curve on a flat television display, hence replicating a curved TV experience in a flat screen, and vice versa as well. This is accomplished by utilizing the concept of multi-view and adding depth of the 2D frame to derive two images for the left and right eye for each viewer, which when seen through any of the existing stereoscopic 3D technologies, gives the perception of a personalized virtual curvature to that particular viewer. This proposal has several advantages compared to the existing mechanically bendable curved TVs. Examples of these advantages include, but are not limited to dynamic control of curvature, achieving extreme curves, automatically adjusting curve along with the content and/or viewer's position, preference and viewing-angle, etc. Moreover, such a system can be used to simulate not only cylindrical or spherical curves, but any other desired curvature. Curved TV effect can be simulated in a flat screen using the basics of 3D vision. Such simulation not only preserves most of the advantages of hard-curved televisions but also add few unique traits, which are not possible with mechanically curved displays.

To further clarify advantages and features of the present disclosure, a more particular description of the invention will be rendered by reference to specific embodiments thereof, which is illustrated in the appended figures. It is appreciated that these figures depict only typical embodiments of the invention and are therefore not to be considered limiting of its scope. The invention will be described and explained with additional specificity and detail with the accompanying figures.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

These and other features, aspects, and advantages of the present disclosure will become better understood when the following detailed description is read with reference to the accompanying figures in which like characters represent like parts throughout the figures.

FIG. 1 illustrates an exemplary method implementable in a 3D display system, according to one embodiment of the present disclosure.

FIG. 2 illustrates another exemplary method implementable in a 3D display system, according to one embodiment of the present disclosure.

FIG. 3 illustrates an exemplary 3D display system, according to one embodiment of the present disclosure.

FIG. 4 illustrates mechanically curved screens known in the art.

FIG. 5 illustrates a spherically dome screen known in the art.

FIG. 6A illustrates the use of active shutter glass technology for viewing 3D contents by single user.

FIG. 6B illustrates the use of active shutter glass technology for viewing separate contents using multi-view technology.

FIG. 6C illustrates combination of FIGS. 6A and 6B, i.e., the use of active shutter glass technology for viewing separate 3D contents using multi-view technology.

FIG. 7A illustrates a normal flat screen view without any perception of curvature. FIG. 7B illustrates a hard curved display screen;

FIG. 7C illustrates a stereoscopic view giving a perception of curvature.

FIG. 8A illustrates multi-view with 3D-curve, where each viewer sees his own customized curved view, and his own customized curved content.

FIG. 8B illustrates locking the curvature centre to the viewer, where curvature is adjusted automatically with users distance.

FIG. 9A illustrates hard curved display, where angled viewers won't get asymmetric curved view.

FIG. 9B illustrates soft curved display, where every viewer can get a symmetric curvature.

FIG. 9C illustrates (1) simulation of flat content in a hard curved display, and (2) corner viewer can see symmetric curve on a hard-curved display using 3D glasses.

FIG. 10A illustrates auto adjustment of frame curvature parameter in a video, depending upon the content.

FIG. 10B illustrates auto adjustment of curvature based on the resolution and type of the photograph, for example, close-up, landscape, etc.

FIG. 11A illustrates typical three projector cinerama setup illustrates curved screens in theatres.

FIG. 11B illustrates curve vs flat screen.

FIG. 11C illustrates view angle of planar and curved screens of same dimensions.

FIG. 11D illustrates an intensely curved display is perceived bigger than a mildly curved display.

FIGS. 12B & 12C illustrates typical smile box simulation of an original image shown in FIG. 12A.

FIG. 13 illustrates geometry of depth-map of a cylindrical curve.

FIG. 14A illustrates a surface plot of depth map of cylindrical curve.

FIG. 14B illustrates a corresponding depth map of the cylindrically curved display.

FIG. 14C illustrates a surface plot of depth map of a spherical dome.

FIG. 14D illustrates a corresponding depth map of the spherical dome.

FIG. 15 illustrates ray diagram of normal view with no 3D effect.

FIG. 16A illustrates pop-out 3D view when viewed from stereoscopic system.

FIG. 16B illustrates left eye view of a popped-out 3D.

FIG. 16C illustrates right eye view of a popped out 3D.

FIG. 17 illustrates ray diagram of behind the screen 3D view.

FIG. 18A illustrates left eye view of behind-the-screen 3D.

FIG. 18B illustrates right eye view of behind-the-screen 3D.

FIGS. 19A and 19B illustrate parallax relations with respect to the screen.

FIGS. 20A and 20B illustrate behind-the-screen depth effect.

FIG. 21A illustrates left and right data shift needed in the process of generating L-R image pairs.

FIGS. 21B and 21C illustrates problems associated with shifting.

FIG. 22 illustrates manual adjustment of curvature parameters (z-shift).

FIGS. 23A to 23D illustrate adjustment of curvature centre (y-shift).

FIG. 24 illustrates centre of curvature is locked to a moving viewer (an x-shift of viewer).

FIG. 25 illustrates centre of curvature is locked to a viewer moving along z-axis.

FIGS. 26 and 27 illustrate multiple viewers where each viewer is viewing his own customized curvature.

FIG. 28 illustrates block diagram of proposed system.

FIG. 29 illustrates a flow chart of the sequence of operations.

FIG. 30 illustrates a flow chart for estimating curvature parameters.

FIG. 31 illustrates a flow chart for user motion.

FIG. 32 illustrates a structure diagram to generate L-R Image sequences for curved view.

FIG. 33 illustrates use of 3D with polarized glasses.

FIG. 34 illustrates use of Polarized glasses and active shutter glasses arrangement to realize 3D with one technology and multi-view with the other.

Further, skilled artisans will appreciate that elements in the figures are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those of ordinary skill in the art having benefit of the description herein.

### DETAILED DESCRIPTION

For the purpose of promoting an understanding of the principles of the invention, reference will now be made to the embodiment illustrated in the figures and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying figures.

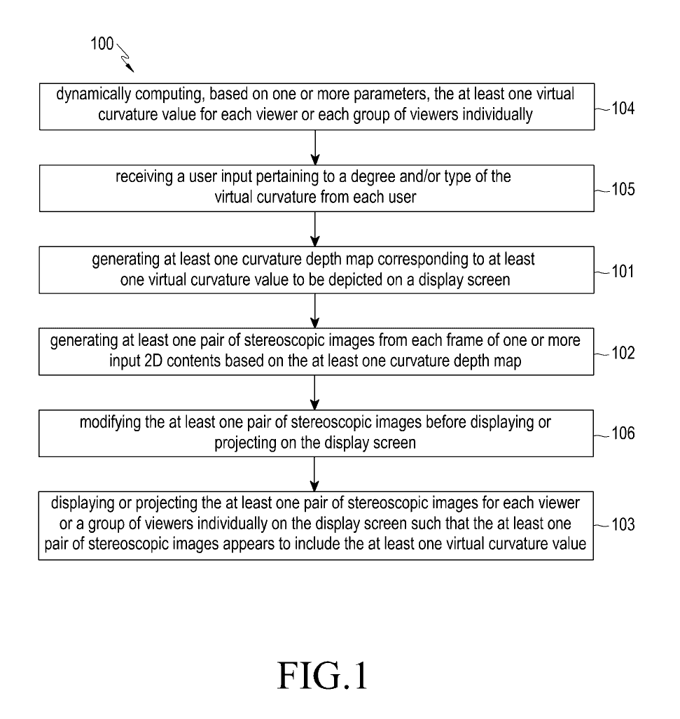

FIG. 1 illustrates a method implementable in a 3D display system in accordance with an embodiment of the present disclosure.

Refer to FIG. 1, the method 100 comprising: generating 101 at least one curvature depth map corresponding to at least one virtual curvature value to be depicted on a display screen; generating 102 at least one pair of stereoscopic images from each frame of one or more input 2D contents based on the at least one curvature depth map; and displaying or projecting 103 the at least one pair of stereoscopic images for each viewer or a group of viewers individually on the display screen such that the at least one pair of stereoscopic images appears to include the at least one virtual curvature value.

In a further embodiment, generating 102 the at least one pair of stereoscopic images comprises generating 102 the at least one pair of stereoscopic images corresponding to multiple input contents in a spatial or temporal multi-view arrangement.

In a further embodiment, the method 100 comprises: dynamically computing 104, based on one or more parameters, the at least one virtual curvature value for each viewer or each group of viewers individually.

In a further embodiment, the one or more parameters comprise: frame category, frame resolution, frame aspect ratio, frame colour tone, metadata of a frame, position of a viewer device, distance between the viewer device and a display screen, movement of the viewer device, viewer's preference, screen dimensions, and/or viewing angle.

In a further embodiment, the at least one virtual curvature value is: a value related to horizontally cylindrical, or vertically cylindrical, or spherical, or asymmetric, or substantially flat—with respect to physical curvature of the display screen.

In a further embodiment, the method 100 comprises: receiving 105 a user input pertaining to a degree and/or type of the virtual curvature from each user.

In a further embodiment, the method 100 comprises: modifying 106 the at least one pair of stereoscopic images before displaying or projecting on the display screen.

In a further embodiment, modifying 106 the at least one pair of stereoscopic images comprises hole-filling and/or averaging the at least one pair of stereoscopic images to deal with missing or overlapping pixels.

In a further embodiment, displaying or projecting 103 the at least one pair of stereoscopic images depicts a virtual screen having a screen size different than actual screen size of the display screen.

In a further embodiment, displaying or projecting 103 the at least one pair of stereoscopic images depicts a virtual curvature different than physical curvature of the display screen.

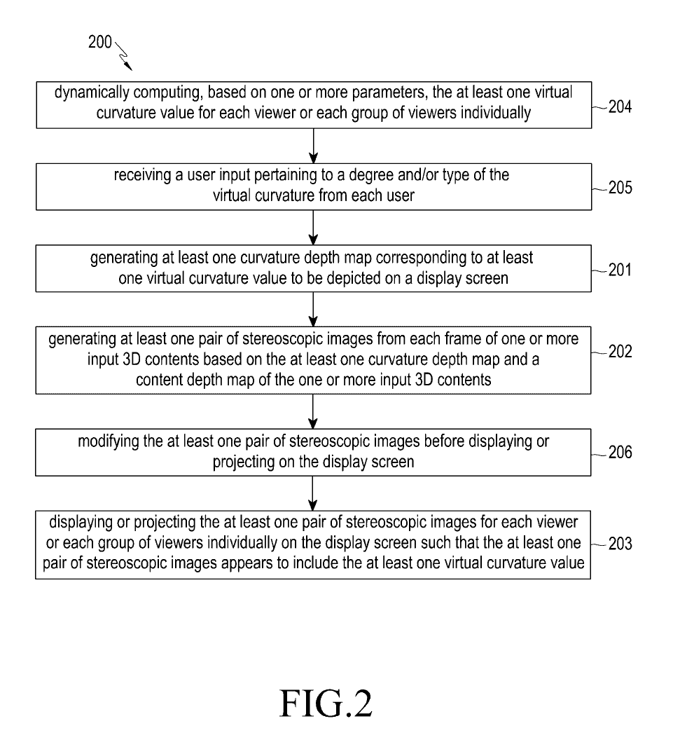

FIG. 2 illustrates a method 200 implementable in a 3D display system in accordance with an embodiment of the present disclosure.

Refer to FIG. 2, the method 200 comprising: generating 201 at least one curvature depth map corresponding to at least one virtual curvature value to be depicted on a display screen; generating 202 at least one pair of stereoscopic images from each frame of one or more input 3D contents based on the at least one curvature depth map and a content depth map of the one or more input 3D contents; and displaying or projecting 203 the at least one pair of stereoscopic images for each viewer or a group of viewers individually on the display screen such that the at least one pair of stereoscopic images appears to include the at least one virtual curvature value.

In a further embodiment, generating 202 the at least one pair of stereoscopic images comprises generating 202 the at least one pair of stereoscopic images corresponding to multiple input contents in a spatial or temporal multi-view arrangement.

In a further embodiment, the method 200 comprises: dynamically computing 204, based on one or more parameters, the at least one virtual curvature value for each viewer or each group of viewers individually.

In a further embodiment, the one or more parameters comprise: frame category, frame resolution, frame aspect ratio, frame colour tone, metadata of a frame, position of a viewer device, distance between the viewer device and a display screen, movement of the viewer device, viewer's preference, screen dimensions, and/or viewing angle.

In a further embodiment, the at least one virtual curvature value is: a value related to horizontally cylindrical, or vertically cylindrical, or spherical, or asymmetric, or substantially flat—with respect to physical curvature of the display screen.

In a further embodiment, the method 200 comprises: receiving 205 a user input pertaining to a degree and/or type of the virtual curvature from each user.

In a further embodiment, the method 200 comprises: modifying 206 the at least one pair of stereoscopic images before displaying or projecting on the display screen.

In a further embodiment, modifying 206 the at least one pair of stereoscopic images comprises hole-filling and/or averaging the at least one pair of stereoscopic images to deal with missing or overlapping pixels.

In a further embodiment, displaying or projecting 203 the at least one pair of stereoscopic images depicts a virtual screen having a screen size different than actual screen size of the display screen.

In a further embodiment, displaying or projecting 203 the at least one pair of stereoscopic images depicts a virtual curvature different than physical curvature of the display screen.

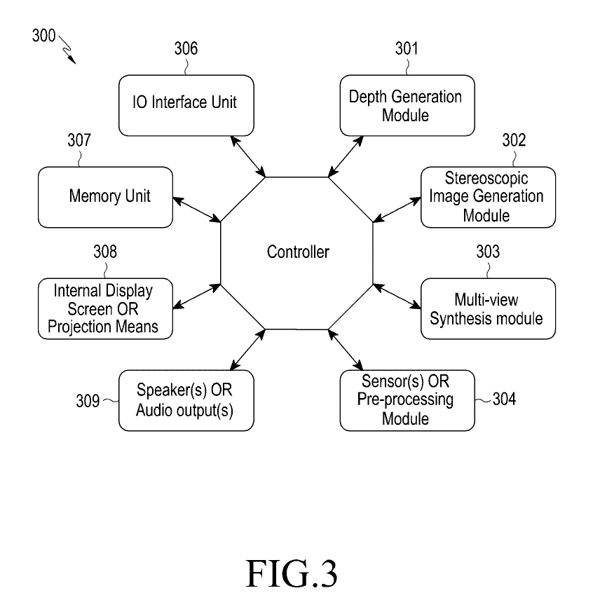

FIG. 3 illustrates a 3D display system 300 in accordance with one or more embodiments of the present disclosure.

In one embodiment, the 3D display system 300 comprises: a depth generation module 301 to generate at least one curvature depth map corresponding to at least one virtual curvature value to be depicted on a display screen; a stereoscopic image generation module 302 to generate at least one pair of stereoscopic images from each frame of one or more input 2D contents based on the at least one curvature depth map; and an internal display screen 308 to display the at least one pair(s) of stereoscopic images for each viewer or a group of viewers individually such that the at least one pair(s) of stereoscopic images appears to include the at least one virtual curvature value; or a projection means 308 to project the at least one pair of stereoscopic images for each viewer or a group of viewers individually on an external display screen (not shown) such that the at least one pair of stereoscopic images appears to include the at least one virtual curvature value.

In another embodiment, the 3D display system 300 comprises: a depth generation module 301 to generate at least one curvature depth map corresponding to at least one virtual curvature value to be depicted on a display screen, which can be internal or external to the 3D display system 300; a stereoscopic image generation module 302 to generate at least one pair of stereoscopic images from each frame of one or more input 3D contents based on the at least one curvature depth map and a content depth map of the one or more input 3D contents; and an internal display screen 308 to display the at least one pair(s) of stereoscopic images for each viewer or a group of viewers individually such that the at least one pair(s) of stereoscopic images appears to include the at least one virtual curvature value; or a projection means 308 to project the at least one pair of stereoscopic images for each viewer or a group of viewers individually on an external display screen (not shown) such that the at least one pair of stereoscopic images appears to include the at least one virtual curvature value.

In a further embodiment, the 3D display system 300 comprises: a multi-view synthesis module 303 to process multiple input contents for display in a spatial or temporal multi-view arrangement.

In a further embodiment, the 3D display system 300 comprises: one or more sensors 304 and/or a pre-processing module 304 to detect one or more parameters affecting dynamic computation of the at least one virtual curvature value for each viewer individually.

In a further embodiment, the 3D display system 300 comprises: an IO interface unit 306 to receive a user input pertaining to a degree and/or type of the virtual curvature from each user.

In a further embodiment, the stereoscopic image generation module 302 is further configured to modify the at least one pair of stereoscopic images to deal with missing or overlapping pixels.

In a further embodiment, the internal display screen 308 or the external display screen is substantially flat.

In a further embodiment, the internal display screen 308 or the external display screen is physically curved.

In a further embodiment, the one or more input 3D contents comprises 2D contents plus the content depth map.

In a further embodiment, the one or more input 3D contents comprises stereoscopic contents.

The 3D display system further comprises a controller 305 may include one or more processors, microprocessors, application specific integrated circuits (ASICs), field programmable gate arrays (FPGAs), or the like. The processing unit 305 may control the operation of the 3D display system 300 and its components.

The 3D display system further comprises a memory unit 306, which may include a random access memory (RAM), a read only memory (ROM), and/or other type of memory to store data and instructions that may be used by the controller 305. In one implementation, the memory unit 306 may include one or more of routines, programs, objects, components, data structures, etc., which perform particular tasks, functions or implement particular abstract data types.

The 3D display system further comprises a user interface (not shown), which may include mechanisms for inputting information to the 3D display system 300 and/or for outputting information from the 3D display system 300. Examples of input and output mechanisms include, but are not limited to a camera lens to capture images and/or video signals and output electrical signals; a microphone to capture audio signals and output electrical signals; buttons, such as control buttons and/or keys of a keypad, to permit data and control commands to be input into the 3D display system 300; speakers 309 to receive electrical signals and output audio signals or just an audio output port 309; a touchscreen/non-touchscreen display 308 to receive electrical signals and output visual information or a projection means 308; a light emitting diode; a fingerprint sensor, any NFC, i.e., near field communication—hardware etc.

The IO interface 306 may include any transceiver-like mechanism that enables the 3D display system 300 to communicate with other devices and/or systems and/or network. For example, the IO interface 306 may include a modem or an Ethernet interface to a LAN. The IO interface 306 may also include mechanisms, such as Wi-Fi hardware, for communicating via a network, such as a wireless network. In one example, the IO interface 306 may include a transmitter that may convert baseband signals from the controller 305 to radio frequency (RF) signals and/or a receiver that may convert RF signals to baseband signals. Alternatively, the IO interface 306 may include a transceiver to perform functions of both a transmitter and a receiver. The IO interface 306 may connect to an antenna assembly (not shown) for transmission and/or reception of such RF signals.

The 3D display system 300 may perform certain operations, such as the methods 100 and 200. The 3D display system 300 may perform these operations in response to the controller 305 executing software instructions contained in a computer-readable medium, such as the memory unit 307. A computer-readable medium may be defined as a non-transitory memory device. A memory device may include spaces within a single physical memory device or spread across multiple physical memory devices. The software instructions may be read into the memory unit 307 from another computer-readable medium or from another device via the IO interface 306. Alternatively, hardwired circuitry may be used in place of or in combination with such software instructions to implement the methods 100 and 200. Thus, implementations described herein are not limited to any specific combination of hardware circuitry and software instructions.

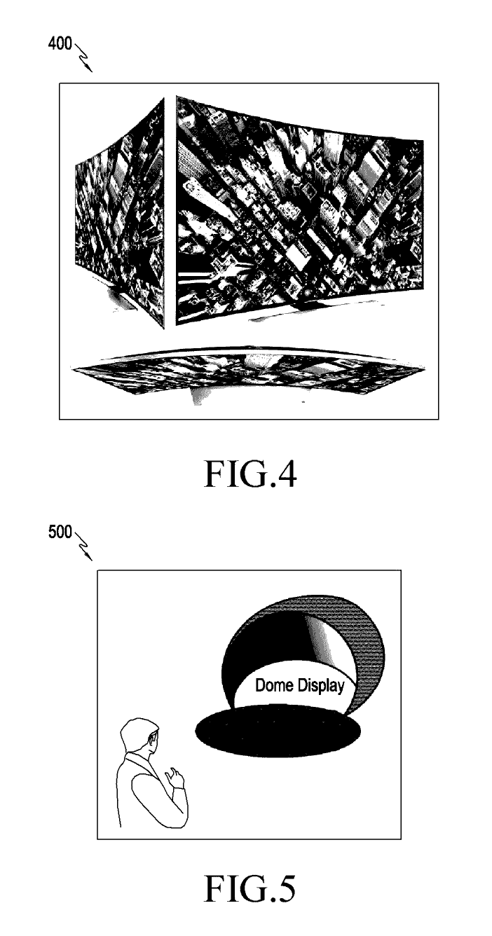

FIGS. 4 and 5 illustrate a variety of mechanically curved screens 400 and a spherical dome screen 500 respectively, which are known in the art.

These are generally considered to provide unique advantages compared to flat screens, for example, providing immersive experience and allowing a wider field of view. Such screens 400, 500 basically provide curved trajectory similar to a person's horopter line, thereby allowing the maintenance of a constant focus length. It facilitates eyes to be more relaxed as content is displayed in a circular plane of focus. That is, the distance between a viewer's eyes and such a screen is substantially constant in the screens 400, 500, unlike flat screens. In a flat screen, the middle part of the flat screen is closer to eyes than the edges of the flat screen. This leads to subtle images and colour distortion from a viewer's perspective. The larger is the flat screen and the closer is the distance from the screen, distortion becomes more noticeable. Such distortions do not happen in mechanically curved or spherical dome screens. Further, mechanically curved or spherical dome screens feel brighter because the light coming from screen is focused from the centre of curvature of the screen. Furthermore, the curved televisions also have artistic value.

Once a user buys a device having a display screen, such as a television, the user expects to use the same for few years. There is a need to realize a curved screen in a flat screen or vice versa, so that, if a flat screen owner want to visualize a curved screen or vice versa, it is still possible without buying another device. Although, there also exists adjustable mechanical curved screens, which can mechanically bend a flat screen using servo motors to achieve a desired curvature. Such physically adjustable screens lack dynamic adjustment of curvature while watching multimedia contents because they work on a manual input from a viewer that is used to pre-adjust the physical curvature.

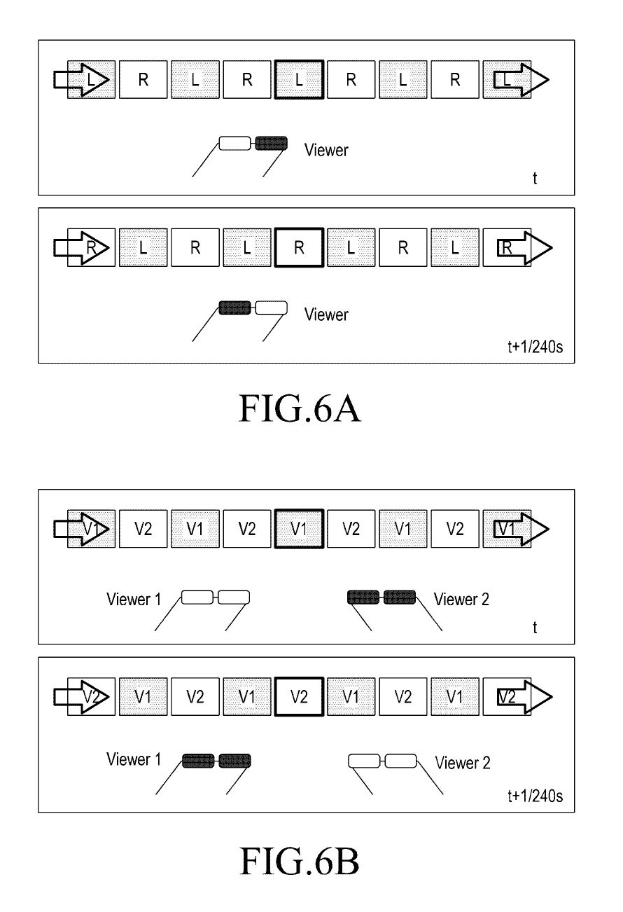

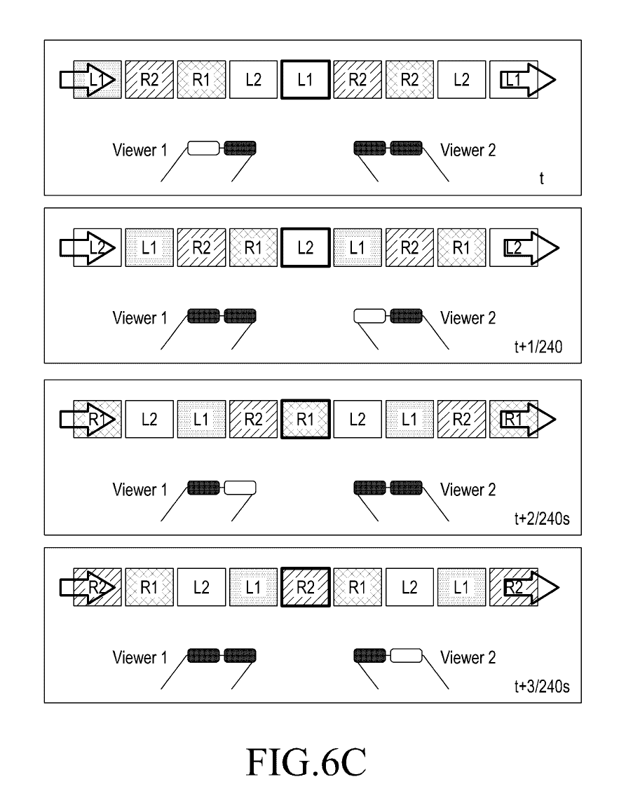

Majority of high end televisions come with 3D technology. Such 3D TVs are known to provide realistic view of video content by providing the illusion of pop-out or behind the screen. To this end, stereoscopic 3D is one popular mechanism in which depth illusion is created by displaying slightly shifted images for the left and right eyes of a viewer. One other technology that is gaining popularity is Multi-view. Multi-view is the concept of sharing same screen between multiple viewers on either spatial or temporal basis. One of the techniques for temporal sharing of a screen involves active shutter glasses. For a two viewer setup, even frames are shown to the first viewer and the odd frames are shown to the second viewer by use of active shutter glasses. The concept of 3D and -multi-view can be clubbed together, wherein each viewer or each group of viewers can see a unique 3D content. This can be achieved by sharing video display frequency as shown in FIGS. 6A-6C.

More specifically, FIG. 6A illustrates 3D viewing with active shutter glasses in a 240 Hz display with each eye getting half of this frequency to view Left (L) and Right (R) frames respectively. FIG. 6B illustrates multi-view with active shutter glasses with each viewer getting half said frequency to view separate contents (V1, V2). FIG. 6C illustrates multi-view with 3D viewing, wherein each viewer can see unique 3D content (L1, R1 or L2, R2). For two viewers, each viewer gets half the frequency, while each eye of the viewer gets quarter of the frequency.

In order to display the content interactively, the position of a viewer can be tracked on the fly. Viewer tracking can be achieved by several means. One example of said means is binocular vision, where depth is estimated from the offset of common content between two images captured from two cameras placed at two different locations in space. Another example is depth from defocus, where depth is estimated from the amount of blur in individual objects in a scene.

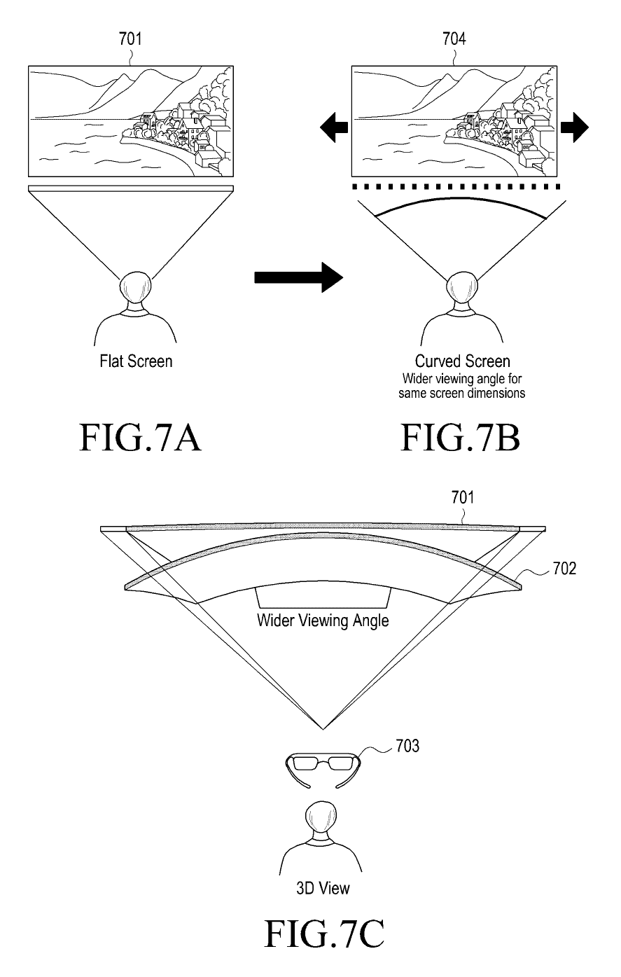

FIG. 7A illustrates a viewer viewing a flat display screen 701 without glasses and FIG. 7B illustrates a hard curved flat display screen 704 without glasses. On the other hand, FIG. 7C illustrates that a user wearing 3D glasses 703 sees a popped out view 702 of the same flat display screen 701 according to the present disclosure, wherein each user can configure his/her own curvature based on individual preferences.

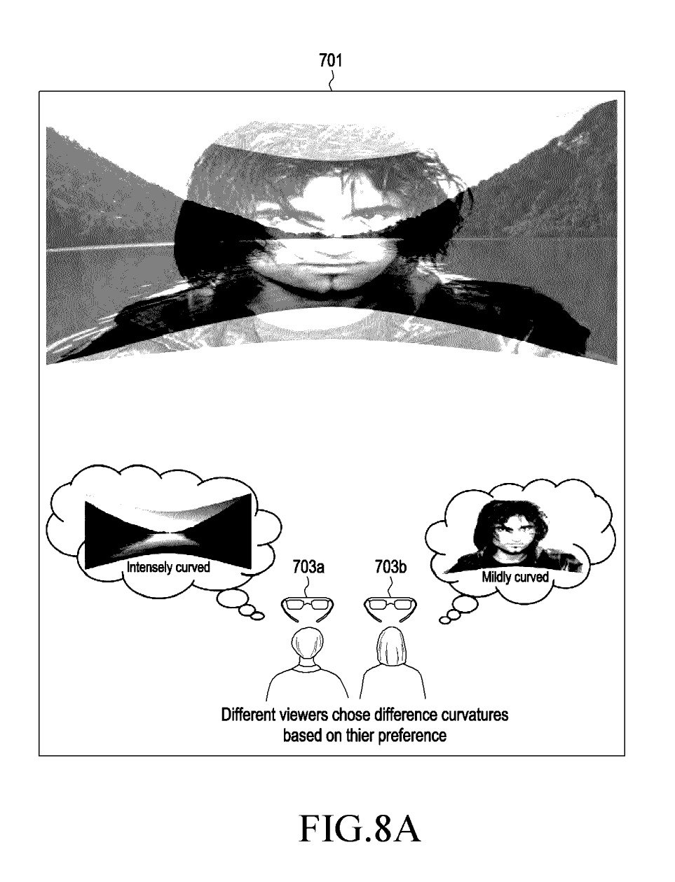

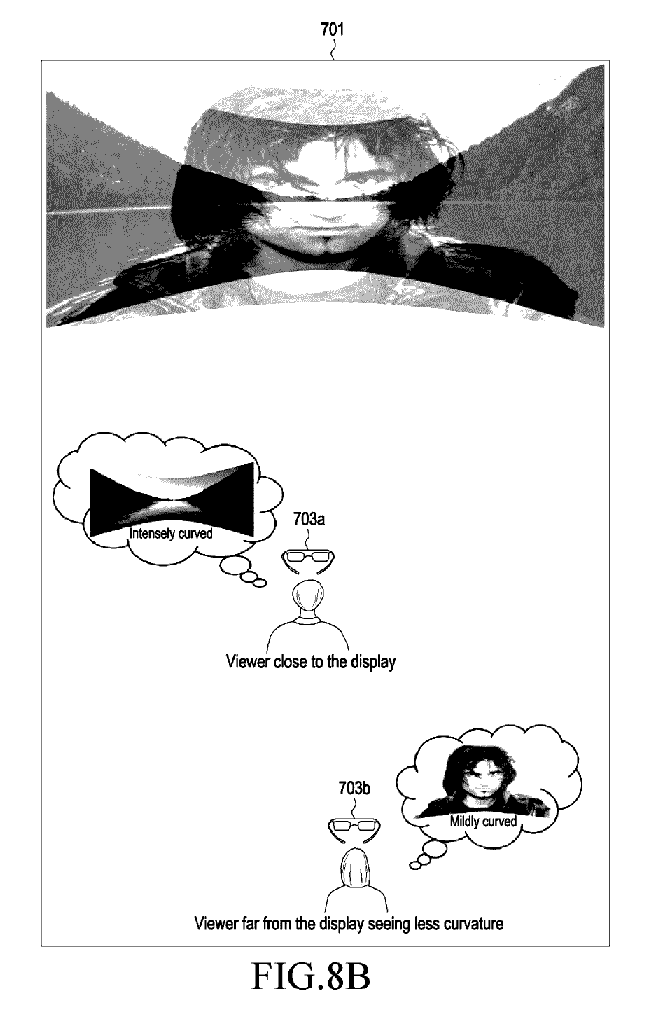

FIG. 8A illustrates multi-viewing with virtual curve on a flat screen 701, wherein each viewer sees his own customized curved view, and his own curved content. In other words, multiple users can view different contents with different virtual curvature using their active shutter glasses 703a, 703b. It can be observed that the landscape scene is deeply curved and person's portrait scene is mildly curved. Basically, each user can see personalized 3D content independent of other users with virtual curvature based on one or more parameters. Examples of such parameters comprise, but are not limited to frame category, frame resolution, frame aspect ratio, frame colour tone, frame's metadata, viewer's position, viewer's distance, viewer's movement, viewer's preference, screen dimensions, viewing angle, etc.

FIG. 8B illustrates locking of the viewer to the centre of curvature, wherein curvature is adjusted automatically with user's distance or vice versa. However, an automatic selection of curvature can be preferred based on the viewer's distance and position. As shown, the lady is sitting far from the screen, hence, sees a mild curvature, whereas the gentleman is located nearby, who visualizes a deep curvature. This curvature is selected automatically, placing the viewer on the axis of the cylindrical-curve.

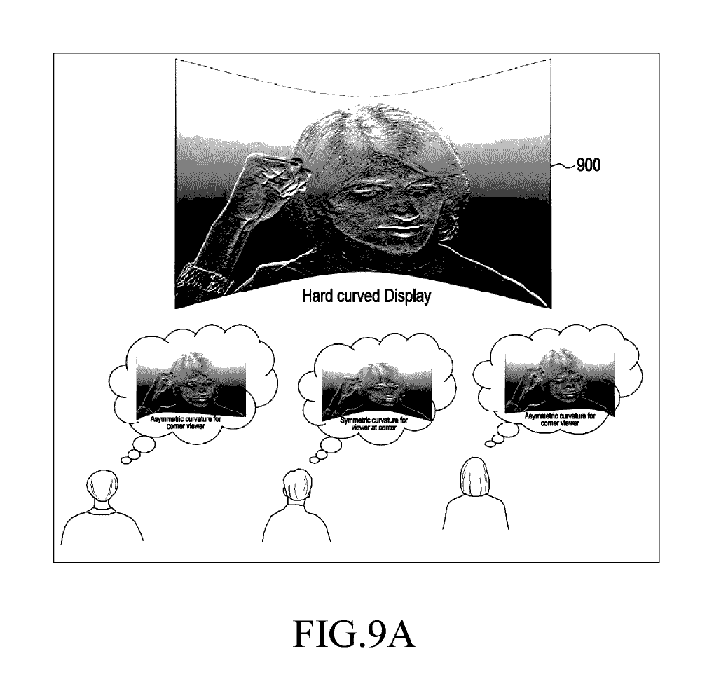

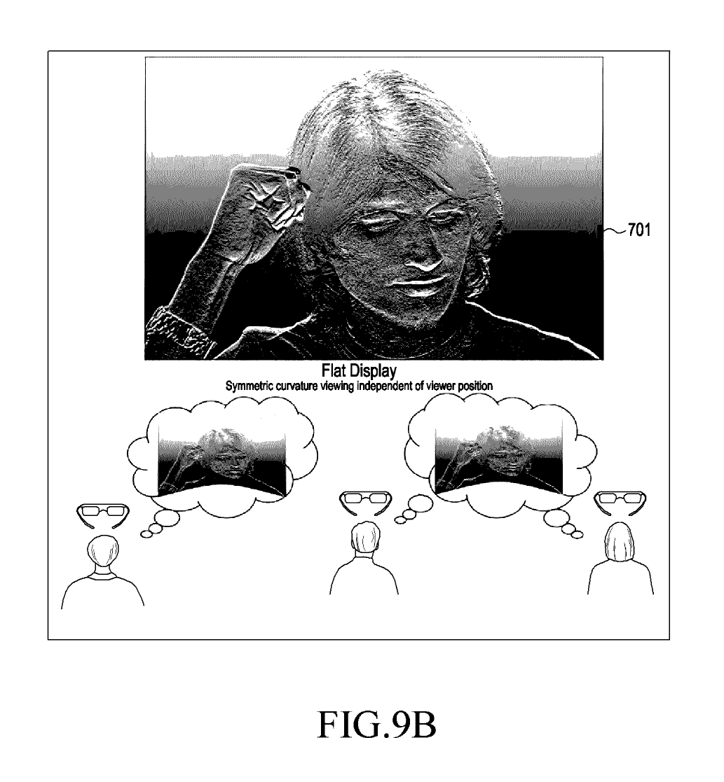

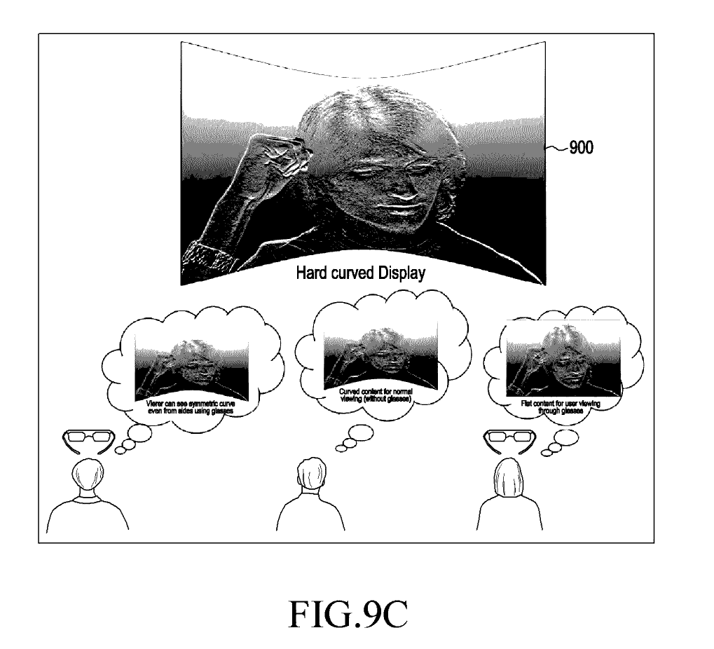

FIG. 9A illustrates a hard curved display 900 known in the art, where angled viewers won't get a symmetric curved view due to normal viewing problems associated with hard-curved displays. The users located at the centre can see a symmetric curvature, whereas the viewers viewing the display from the corners experience asymmetric curve as shown. The gentleman and the lady on the extreme right visualize an asymmetric curve because of their odd position relative to the hard curved display 900; whereas the youngster in the centre views a symmetric curve. This problem is more noticeable in big screens. For example, viewer's sitting in corner seats of a cinema hall, especially in front rows, generally experience such problems.

Above mentioned shortcomings can be addressed by simulating a curve in a flat screen 701. The depth map is adjusted in such a way that, a viewer viewing the display from corners can be made to visualize content with symmetric curves. As can be seen in FIG. 9B, no matter where the viewer is located, everyone enjoys a symmetric curve due to a soft curved display as per the present disclosure. Accordingly, each viewer can get a symmetric curvature irrespective of his/her position with respect to the flat display screen, thereby causing eyes to be more relaxed and enriching the user experience. Moreover, facilitating a symmetric-curve viewing can be done in hard-curved displays as well. As shown in FIG. 9A that a user viewing from corner of a hard-curved display experiences an asymmetric curve. However, such distortions can be avoided by simulating a depth map, which nullifies this asymmetry and provides the viewer a symmetric curve viewing even from the corners. FIG. 9C illustrates the simulation of flat content in a hard curved display. The gentleman on the left bottom can enjoy a symmetric-curve view by wearing glasses. This view is quite similar to the view of the youngster at the centre without glasses. Also one can make a hard-curved TV display a flat screen as per user requirements. Such a case is depicted in FIG. 9C as well. The lady in the right corner visualizes a flat TV experience in a hard-curved TV by wearing glasses. This can be considered as a negation of the case where a curved content effect is created in a flat screen.

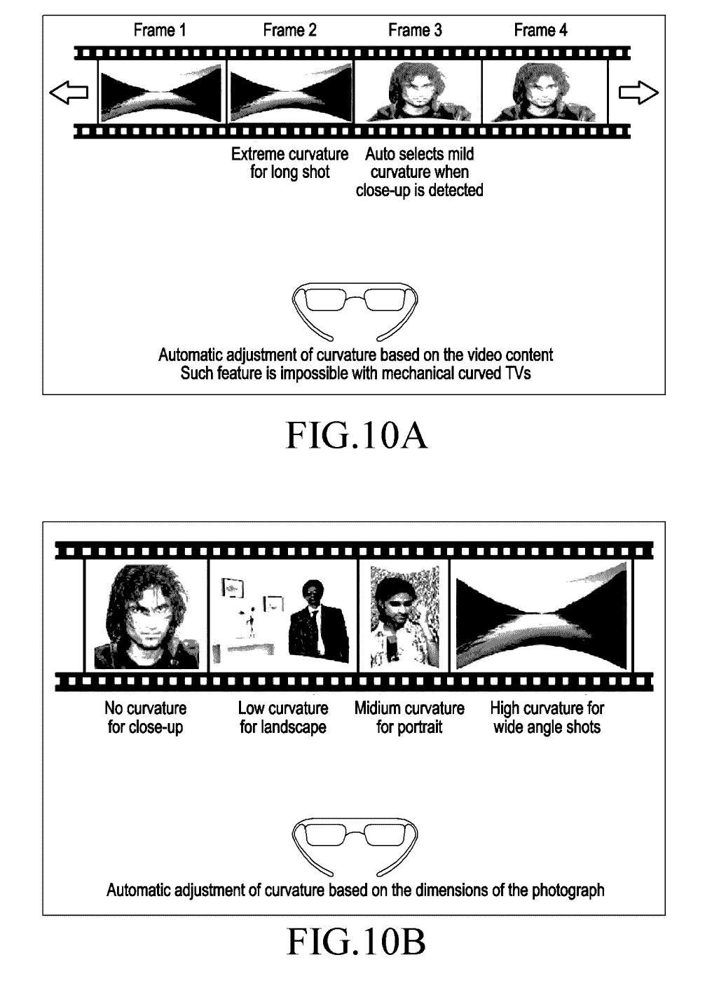

FIG. 10A illustrates the auto adjustment of frame curvature in a video, depending up on the content itself. Basically, different curvatures can be applied to different frames of the video based on the video content. In one example, an extreme curvature may be applied when a wide angle shot is detected. In another example, a mild curvature may be applied when a close up shot is detected. As can be seen in FIG. 10A, frames 1 and 2 are wide angle shots, hence an extreme curvature is applied; whereas frames 3 and 4 are close up shots, hence the mild curvature is applied.

FIG. 10B illustrates the auto adjustment of frame curvature based on the resolution and or aspect ratio of images. For example, there may be no curvature for a close-up (1:1 aspect ratio), low curvature for landscape (3:2 aspect ratio), medium curvature for portrait (2:3 aspect ratio), and high curvature for wide angle shots (16:9 aspect ratio). Analogy of the above mentioned use cases with the theory provided in this article can be found in subsequent paragraphs.

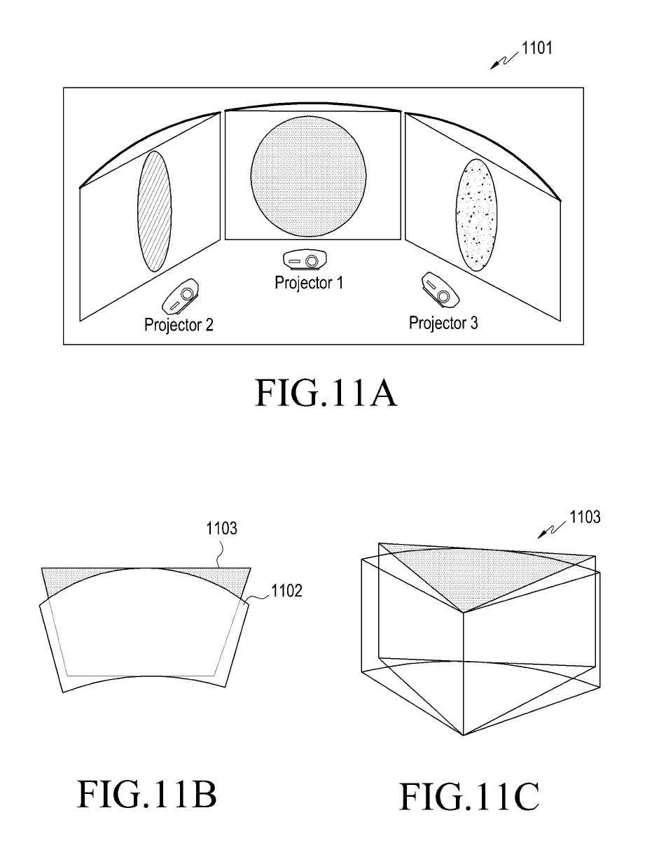

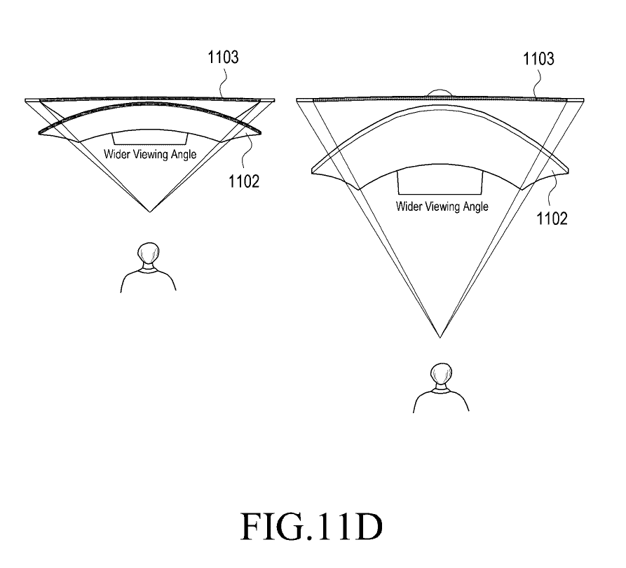

FIG. 11A depicts a typical cinema setup to realize curved screens in theatres. Though curved screens are popular in theatre screens, including Cinerama, they were not commercialized in small screen video displays till recently. FIG. 11B illustrates a curved screen 1102 vis-a-viz with a flat screen 1103. The curved screens are marketed as providing an immersive experience, and allowing a wider field of view 1103 as shown in FIG. 11C. One may notice the view angle of planar and curved screens of same dimensions. Such curved screens are becoming popular due to unique advantages compared to flat screens. FIG. 11D illustrates that a curved screen 1102 is perceived bigger than a corresponding flat screen 1103, especially for deeper curves.

Many motion picture experts believe that the curve would have to be curvier than what the commercial curved televisions offer, to make a significant impact on human eye. Currently commercialized LCD screens are providing curvature of up to 5 meters (16.4 feet), which makes the corners 1.4 inches popped out of the centre of the screen. With soft-curves, such effect can be created in no time, as achieving desired curve is no more a mechanical constraint. Also, restrictions of the hard-curved TVs demands users to position from the centre of the TV to avoid distortions. Finally, commercially available TVs are horizontally curved screens (a 1-D curve). 2-D and multi-dimensional curves are not commercialized yet, because of the lack of flexibility to convert the commercialized flat TVs into 2D-curves and spherical domes. To this end, methods exist to simulate a curved effect on a 2D screen by performing a geometric transform on an image. One exemplary method is the Smile Box simulation of curved screens.

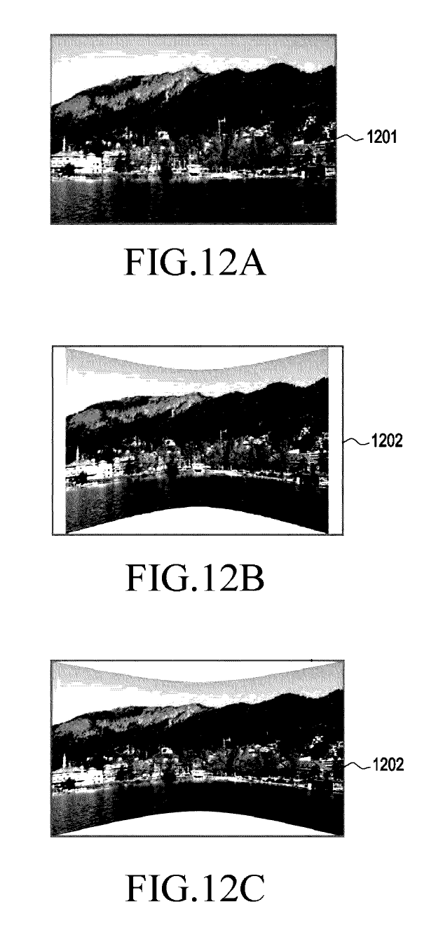

FIG. 12A illustrates an original image 1201, while FIGS. 12B and 12C illustrate exemplary smile box stimulations 1202 of a curved screen. Smile Box simulation restricts itself to a spherical curve simulation and had not explored a stereoscopic extension, wherein the curve is showcased in 3D with the concept of depth maps. Simply applying 2D to 3D conversion on an image with simulated spherical curves as shown in doesn't cadre to the purpose, as the real depths of the 3D curve won't be considered in such simulation. Hence, there is a need for reliable and effective ways in which soft curves can be realized in multiview scenario to address the short comes of mechanical curved TVs and that of 2D-simulation curves. Curved screen effect can be simulated in a flat screen using the basics of 3D vision preserving most of the above mentioned advantages of hard-curved televisions. Proposed method implements such possibilities by generating the depth map of a curve to derive stereoscopic image pairs. Also, proposed method won't affect the look and feel of true-3D videos, as depth corresponding to the virtual-TV-curve will be added to the depth map of the left and right eye-frames of a 3D video.

One of the ways to implement the present disclosure is explained now. There may be other ways of implementing the present disclosure based upon requirements as well as interpretation of the idea. There are three major steps in the proposed me thod to get the stereoscopic pair images. First is depth map generation, followed by parallax calculation for left and right view images, and disocclusion plus averaging in the end.

In order to create stereoscopic images for a curved display, first a depth map of the curve is created. This can be done using the assumption that a curved television is a part of a cylinder with a specific radius of curvature. Hence, the curve of a curved TV can be represented with the equation of a cylinder, whose cross section converges on to a circle.

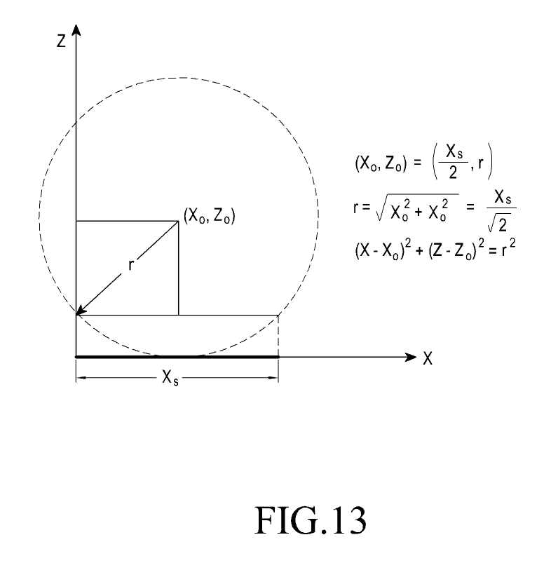

FIG. 13 illustrates the geometry of depth-map of a 1-D curve along the horizontal axis. Equation of a curved-display with circular curvature can be represented as:

C(x,y)=z(x,y)=zₒ+{square root over ((r²−(x−xₒ)²))} (1a)

Where r is the radius of curvature, (xₒ,zₒ) is the center of the circle, whose sector-curve forms the curve of the television, C(x,y) is the 1-D curvature function of the curved TV.

Similarly, a spherical dome can be represented as follows:

z(r,y)=zₒ+{square root over ((r²−(x−xₒ)²−(y−yₒ)²))} (1b)

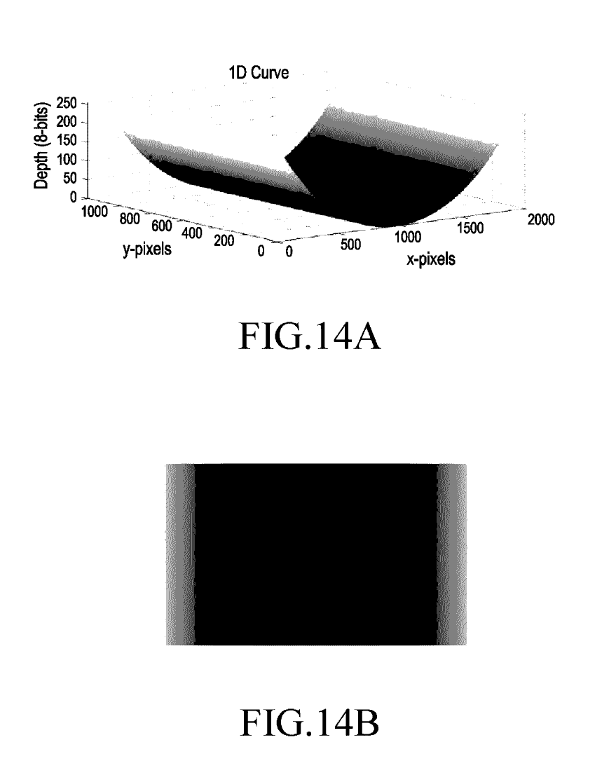

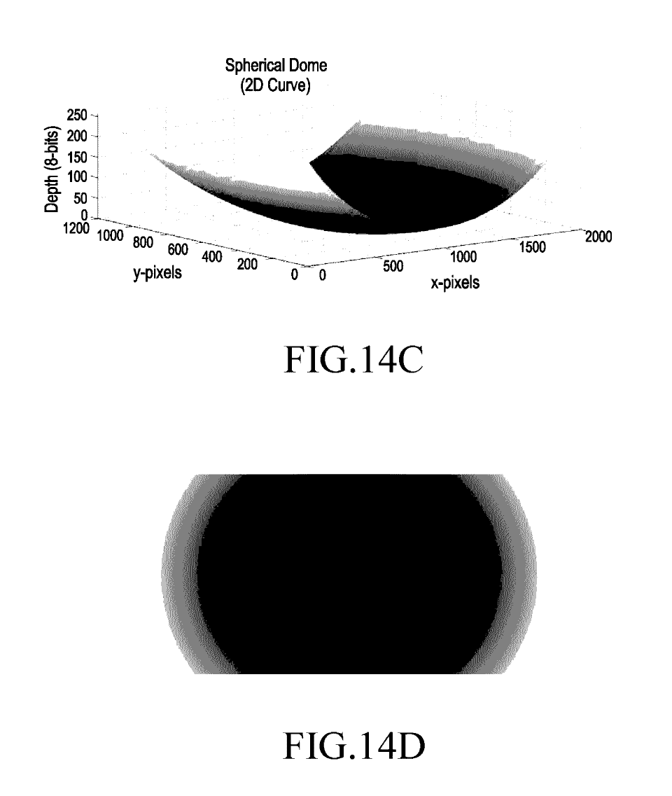

(xₒ,yₒ,zₒ) is the center of the circle, with r as radius of curvature.

$$( {x}_{o} , {y}_{o} , {z}_{o} ) = ( \frac{{x}_{s}}{2} , \frac{{y}_{s}}{2} , r ) \qquad ( 1 c )$$

Where xₛ and yₛ are the dimensions of the flat screen along the x and y directions respectively. On this note, FIG. 14a illustrates a surface plot of depth map of cylindrical curve and FIG. 14b illustrates a corresponding depth map of the cylindrically curved display. Similarly, FIG. 14c illustrates a surface plot of depth map of a spherical dome and FIG. 14d illustrates a corresponding depth map of the spherical dome. Those skilled in the art will appreciate that one can always experiment with different radius of curvatures; for FIG. 14d, radius of curvature of

$$r = \frac{{x}_{s}}{\sqrt{2}}$$

is used.

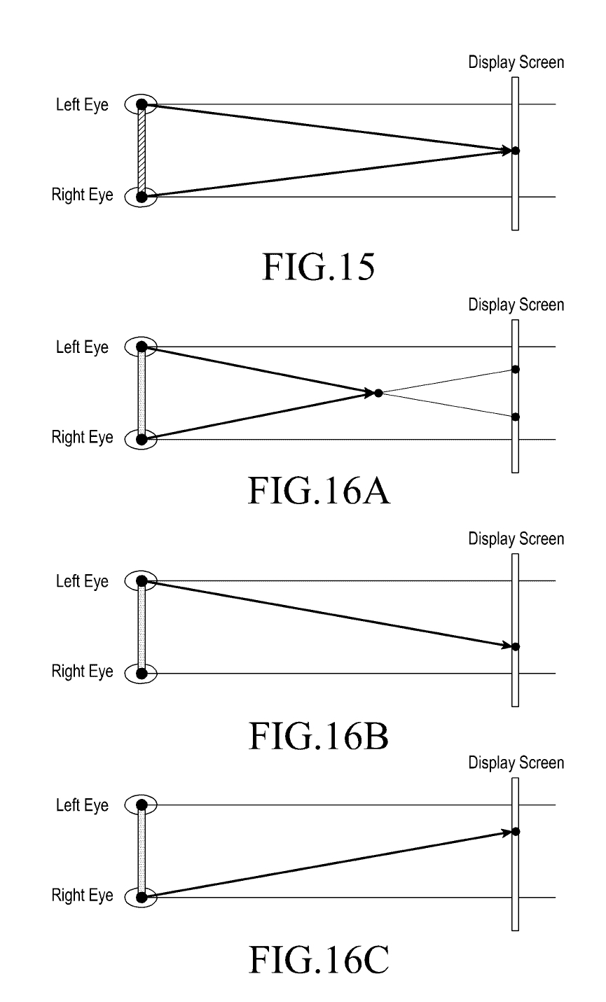

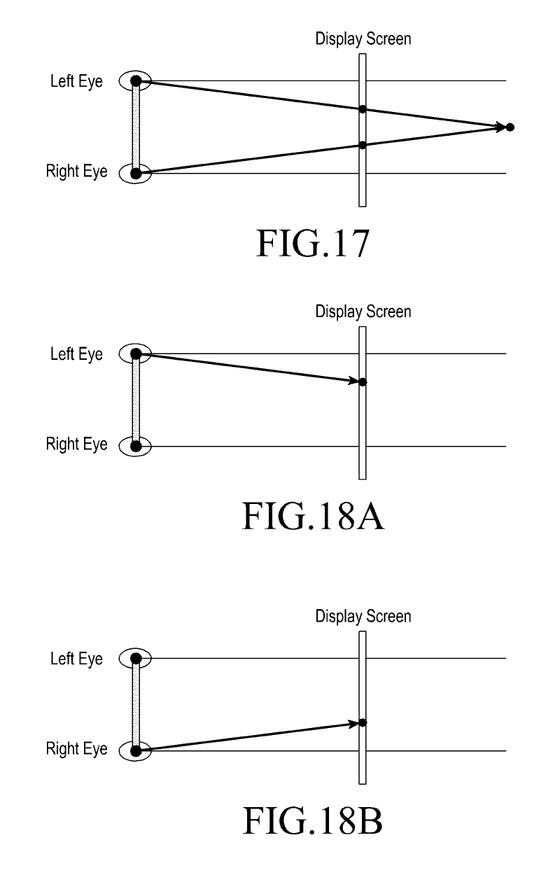

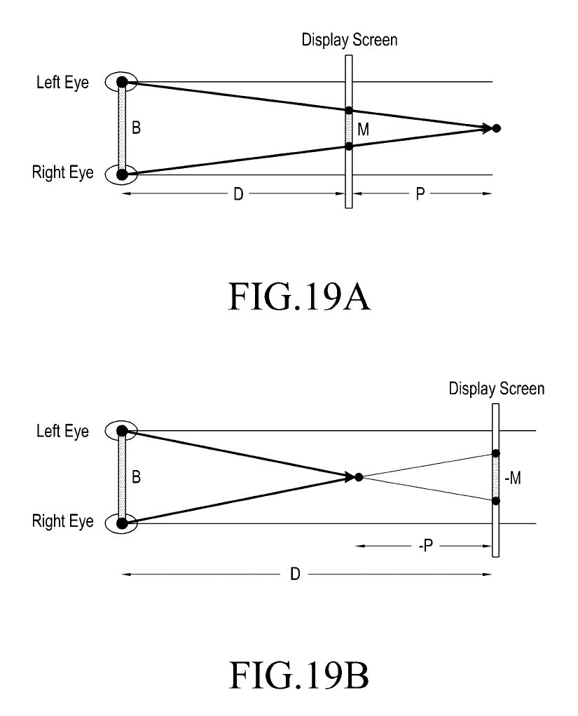

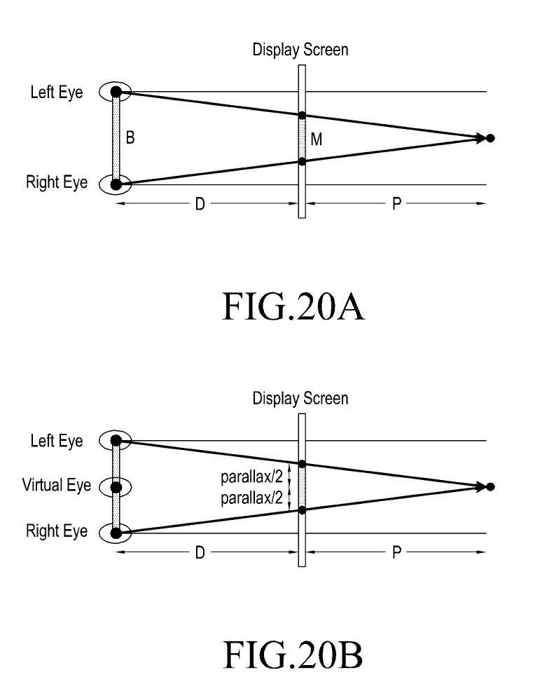

FIG. 15 to FIG. 20 showcases the ray diagrams of normal view, behind-the-screen 3D view and popped-out 3D view. More specifically, FIG. 15 illustrates a normal view with no 3D effect. FIG. 16A illustrates a pop-out 3D view when viewed from a stereoscopic system. FIG. 16B illustrates a left eye view of a popped-out 3D. FIG. 16C illustrates a right eye view of a popped out 3D. The fundamental of convergence point can be clearly seen in FIG. 16A. Though, the left and right eye sees two different points, as in FIG. 16B and FIG. 16C, the brain perceives both the points as one due to the concept of convergence as shown in FIG. 16A. This convergence point is the key to define depth in 3D viewing, facilitating one to see things behind or ahead of the display screen. Convergence point can be placed at various depths by controlling the two corresponding points in the left and right view images of FIG. 16B and FIG. 16C. FIG. 17 illustrates a behind the screen 3D view. FIG. 18A illustrates a Left eye view of behind-the-screen 3D. FIG. 18B illustrates a right eye view of behind-the-screen 3D. FIGS. 19A and 19B illustrate a parallax relation with respect to the screen. More precisely, FIG 19A illustrates a behind-the-screen 3D effect and FIG. 19B illustrates a pop out 3D effect. Here, negative values are used for mathematical convenience. FIGS. 20a and 20b illustrate a behind-the-screen depth effect. More precisely, FIG. 20a illustrate parallax relations with respect to a screen, when M=B/2, and FIG. 20b illustrates a virtual eye view. FIGS. 19 and 20 also showcase various distances, B, D M, and P; which are useful to define relations in creating and interpreting depth-map. Exploiting the correlation between similar triangles in FIG. 20a provides:

$$\frac{B}{D + P} = \frac{M}{P} \qquad ( 2 )$$

Where M is the parallax, which plays a vital role in controlling the convergence point, hence depth. B is the inter-ocular distance, P is the depth into the screen, and D is the viewer to screen distance. P can be represented in terms of Pₘₐₓ and the grey-toned depth map as follows:

$$P = {P}_{max} ( 1 - \frac{depth\_value}{{2}^{n} - 1} ) \qquad ( 3 )$$

As the parallax should be no more than the inter-ocular distance for a convergence point, hence M≦B. With M=Mₘₐₓ=B, from eq. (2), P=Pₘₐₓ=∞ which corresponds to a parallel view. For convenient viewing, Mₘₐₓ=B/2 may be preferred, for which Pₘₐₓ=D.

$$M = \frac{BP}{D + P} \qquad ( 4 )$$

Substituting P from eq. 3 in eq. 4

$$\begin{matrix}M = \frac{{BP}_{max} ( 1 - \frac{depth\_value}{{2}^{n} - 1} )}{D + {P}_{max} ( 1 - \frac{depth\_value}{{2}^{n} - 1} )} & ( 5 ) \\ M = F \{ B , {P}_{max} , depth\_value , n \} & ( 6 )\end{matrix}$$

As Pₘₐₓ=D for Mₘₐₓ=B/2, from eq. (6), one can represent parallax in real dimensions as follows:

$$\begin{matrix}parallex ( in real dimensions ) = M \\ = \frac{BD ( 1 - \frac{depth\_value}{{2}^{n} - 1} )}{D + D ( 1 - \frac{depth\_value}{{2}^{n} - 1} )} \\ = \frac{B ( 1 - \frac{depth\_value}{{2}^{n} - 1} )}{1 + ( 1 - \frac{depth\_value}{{2}^{n} - 1} )}\end{matrix}$$

Typically, for an inter-ocular distance of B=2.5″ and a viewer to screen distance of D=120″, M is in real dimensions (meters/inches) for different depth_value for a given bit-depth, n. One must know the pixel_pitch of the display to convert Mᵣₑₐₗ_{_}_{dimensions} to Mₚᵢₓₑₗₛ. Pixel_pitch can be inferred from the ppi (pixels-per-inch) specification of the LCD display.

$$pixel\_pitch ( in inches ) = \frac{1}{ppi} \qquad ( 8 )$$

In order to reconstruct the left and the right views, parallax must be represented in terms of pixels, which can be done as follows:

$$parallax = {M}_{pixels} = \frac{M}{pixel\_pitch} \qquad ( 9 )$$

One can use eq. (9) to calculate parallax at every pixel of the depth map. Once parallax is calculated for a given system, half the parallax is applied to the origin al image to form left-eye-view image and the rest half to the original image to form the right-eye-view image, as shown in FIG. 20b. Applying the parallax is nothing but shifting specific region of the image left or right by the corresponding number of pixels. A positive parallax corresponds to a left shift and a negative parallax corresponds to the right shift. There are two major problems associated with such shifts, which can be addressed as described in subsequent paragraphs.

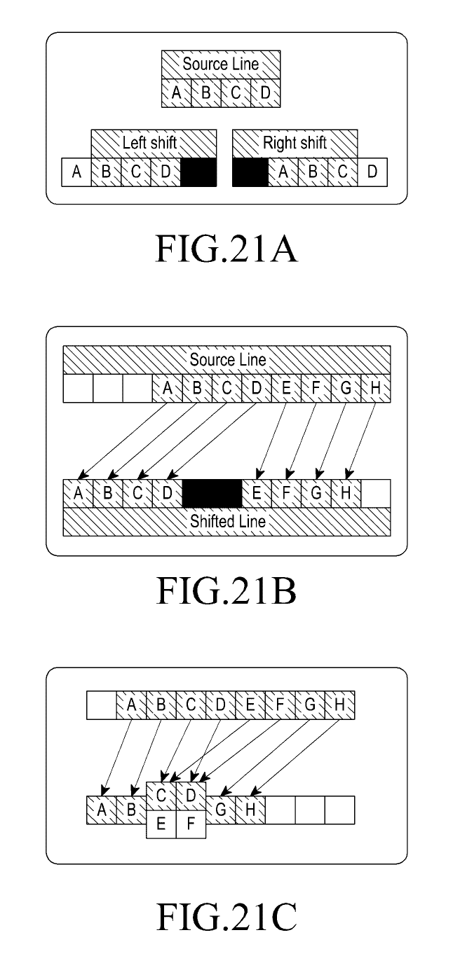

Due to difference in viewpoints, some areas that are occluded in the original image might become visible in the virtual left-eye or the right-eye images, as shown in FIG. 21A. These newly exposed areas, referred to as “disocclusion” in the computer graphics literature, have no texture after 3D image warping because information about the disocclusion area is available neither in the centre image nor in the accompanying depth map shown in FIG. 21B. One of the methods is to fill in the newly exposed areas by averaging textures from neighbourhood pixel s, and this process is called hole-filling. The opposite of the above mentioned effect is shown in FIG. 21C, where one pixel falls on the other, overlapping with the same. Such issues can be addressed by a simple averaging.

This proposed method is very different from traditional 2D to 3D conversion methods as explained below. In the proposed method, a depth map is created not through the conventional way of estimating depth dynamically based on the content of the image frames, but on the basis of the virtual curvature one has to achieve. Hence, the depth map of virtual curvature is constant for a given curvature for all the frames in the video. This saves the depth map computation time greatly, which is extremely useful in on the fly depth map creation during dynamic 3D content generation from 2D frames. During 2D to 3D conversion, it is a common practice to use the current image as one of the views, for example, left view and generate the other view alone or vice versa to minimize conversion cost. Such convenience is not present in the proposed method, as neither of the views is available. One has to generate images corresponding to both the views from the depth map of the curve. Original 2D image must be treated as the centre image of the flat screen with zero depth and the illusion of depth can be created by controlling the convergence point of the left and right views by shifting the pixel content in the corresponding images, as shown in FIG. 19. Time-consuming steps present in conventional depth map creation for 3D viewing including image segmentation/rotoscoping, dynamic depth map creation are not present in the proposed method. Disocclusion and averaging remains in common for both the methods; and must be executed with care for high quality conversion.

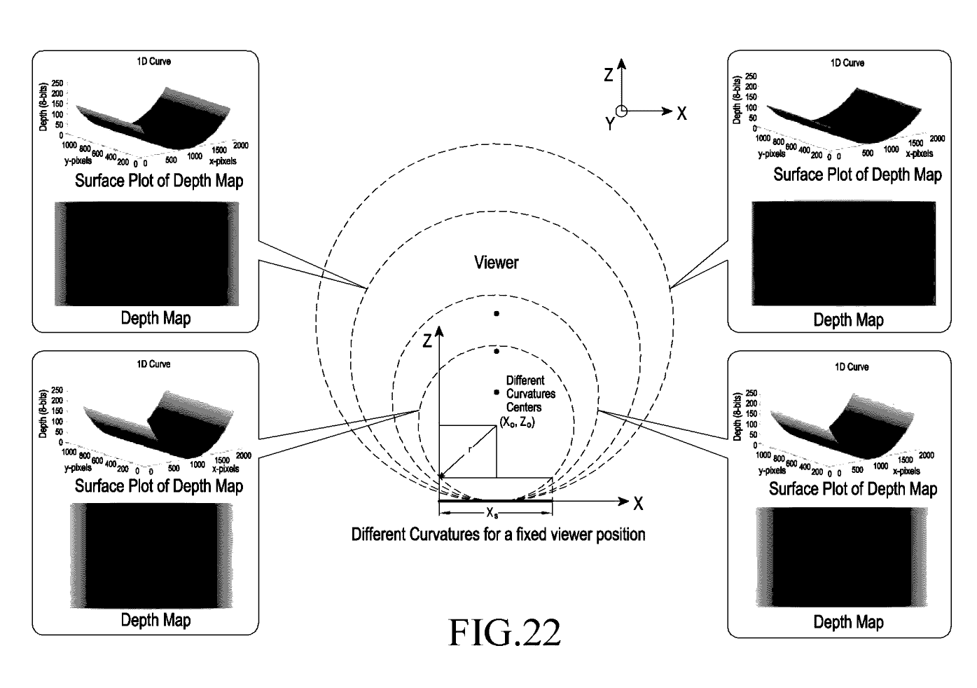

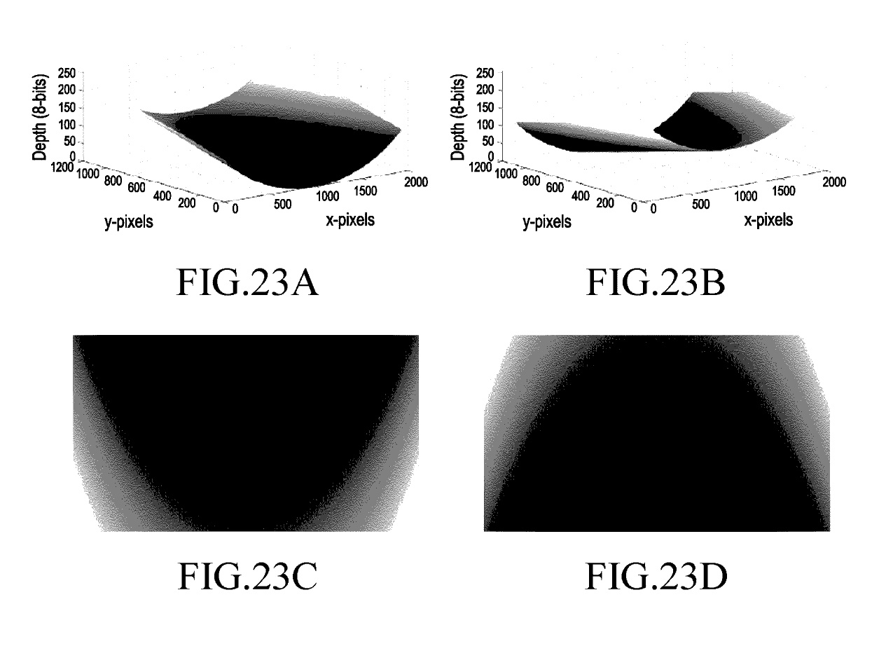

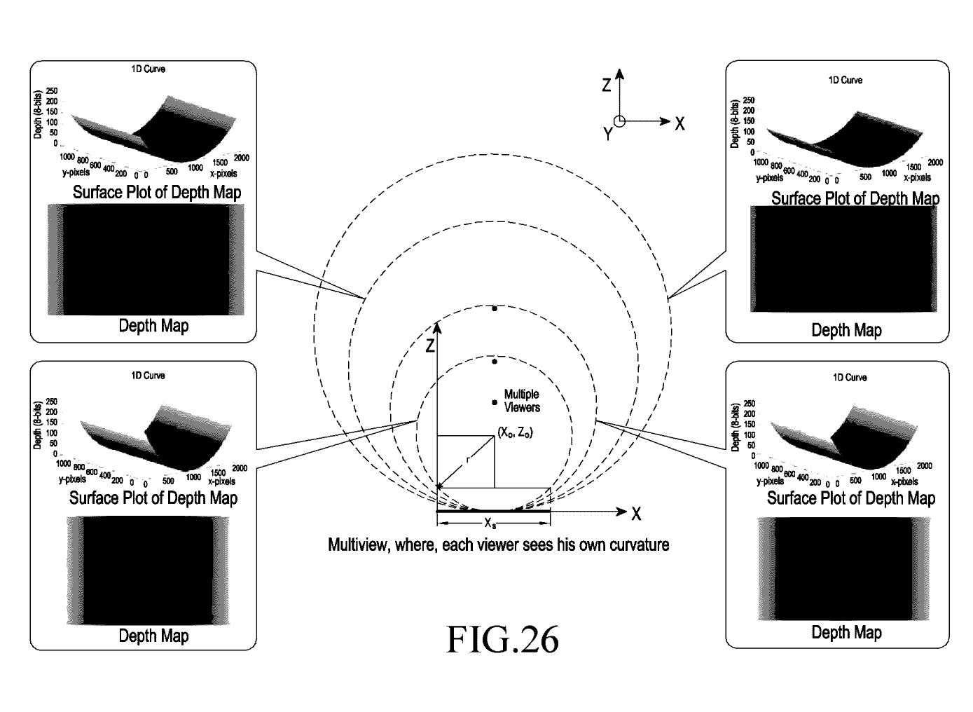

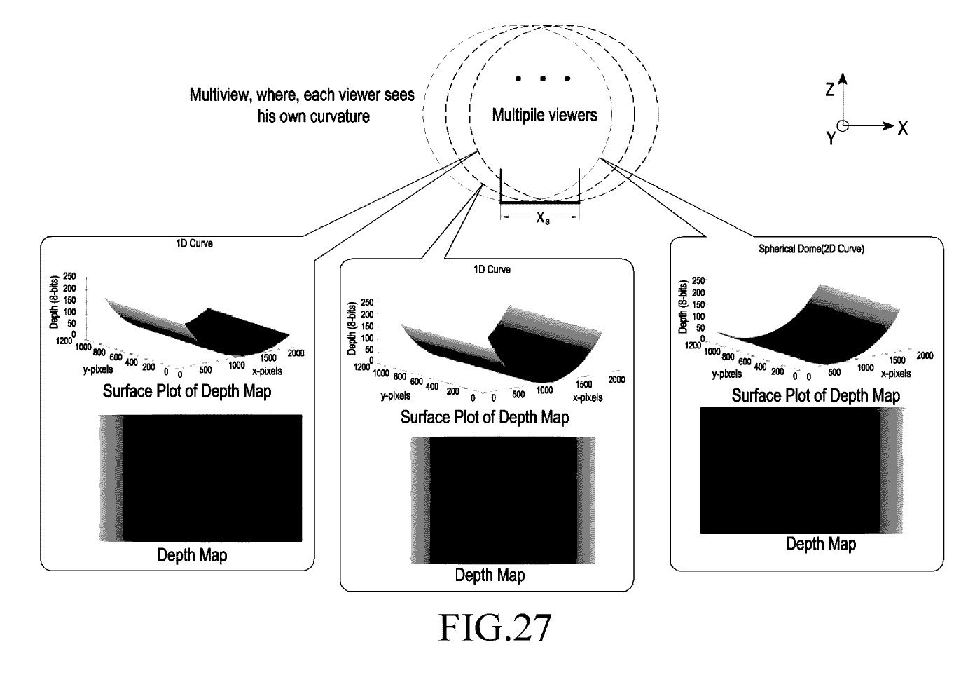

Now, manual control of curvature parameters is described. When a view er changes the curvature parameters manually, the depth map is changed accordingly, as shown in FIG. 22. More specifically, FIG. 22 showcases the users controlling the x-shift of the depth map. The circles in the FIG. 22 are the cross-section of the cylinder. The depth map image and its surface plot are highlighted in the FIG. 22 too. The X, line segment in the FIG. 22 is the width of the display along which a cylindrical curvature is realized. The two black vertical lines on the extremes of the horizontal X, line segment defines the boundaries of the display. Hence, the depth map within the boundaries is the map of interest, and the surface plot of such map is shown in magnified detailed view. Three different curvature centres were marked along with the complete curvature circles for a fixed viewer position for illustration of control of curvature parameter s along x-direction. Image and surface plots of the depth map for a y-shift of centre of curvature are depicted in FIGS. 23a-23d. For cylindrical curvature, a y-shift in centre corresponds to a change in angle of the axis of the cylinder. Further, FIGS. 8A and 8B can be easily correlated with FIG. 22 and FIG. 23. For instance, FIG. 8A can be related with FIG. 22 as both depict manual control of curvature. FIG. 7B can be related with FIG. 26 both depict auto adjustment of curvature with multiple viewers positioned separately along z-direction. FIG. 9B can be related with FIG. 27 where auto adjustment of curvature with multiple viewers positioned separately along x-direction.

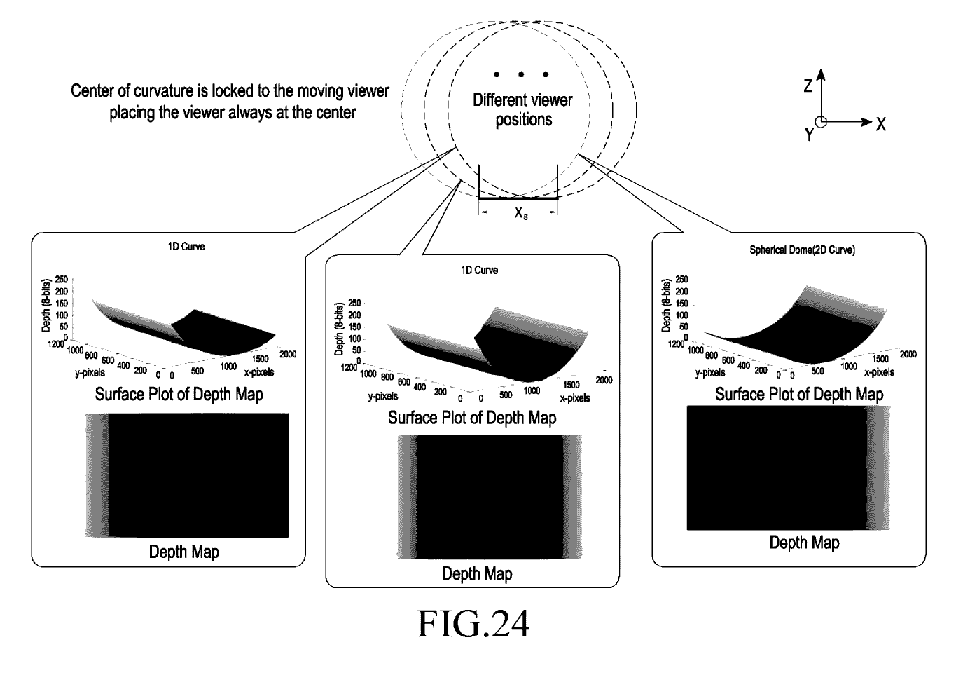

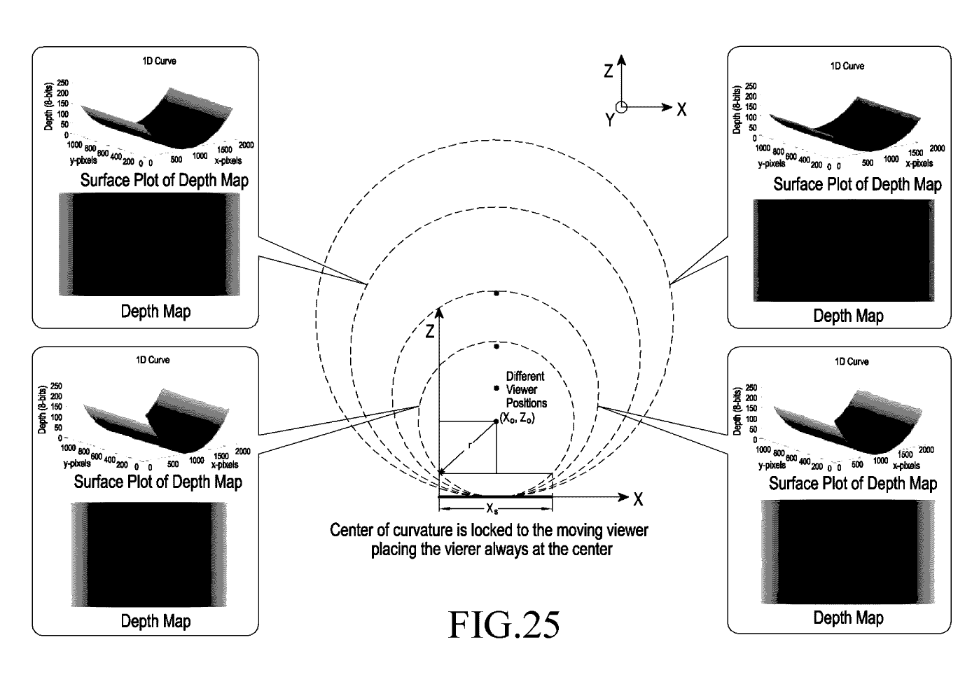

Further, the curvature centre can be locked to a moving user. When the viewer changes his position, his new position is tracked and is updated accordingly. A new depth map with the new user position as the centre is created. Hence, the depth map is dynamically adjusted to give the viewer the best possible visualization. One example is placing the viewer at the centre of curvature of the depth map as shown in FIGS. 24 and 25, wherein FIG. 24 illustrates the centre of curvature being locked to a moving viewer (an x-shift of viewer), while FIG. 25 illustrates the centre of curvature being locked to a viewer moving along z-axis.

Now, a scenario is being described involving multiple viewers with each viewer viewing unique content. In such a multi-view scenario, each viewer is tracked independently, and respective positions are noted. Each viewer is showcased not only a unique content, but also a unique curvature personalized to him. Hence, first viewer's curvature is independent of the second viewers view and vice versa. In this scenario, one viewer's preference of curvature does not affect the other viewer, as each viewer is free to set his own curvature based on his preference. One of the ways to achieve multi-view is with active shutter glasses, where each viewer visualizes his own unique content, and unique curvature. To this end, FIG. 26 illustrates multiple viewers along z-direction, while FIG. 27 illustrates multiple viewers along x direction.

FIG. 9 can be related with the theory provided. There are two cases in FIG. 9C. First case is flat content in hard-curved screen. If the curvature function of the hard-curved television is T(x,y), to get a flat screen experience, make “−T(x,y)” as the depth map to derive L-R images. This will negate the effect of the curvature to get a flat screen effect on a hard-curved television for users viewing through 3D glasses. Second case is symmetric curve in a hard-curved screen to a user located at a corner. If the curvature function of the hard-curved television is T(x,y); and the desired curvature for a particular viewer is m(x,y). Note that m(x,y) is a function of the position of the user. Instead of using m(x,y) as the depth map to be added, use m(x,y)-T(x,y) as the depth map offset to generate L-R images to get the effect of a symmetric curve for a user at corner, viewing through 3D glasses.

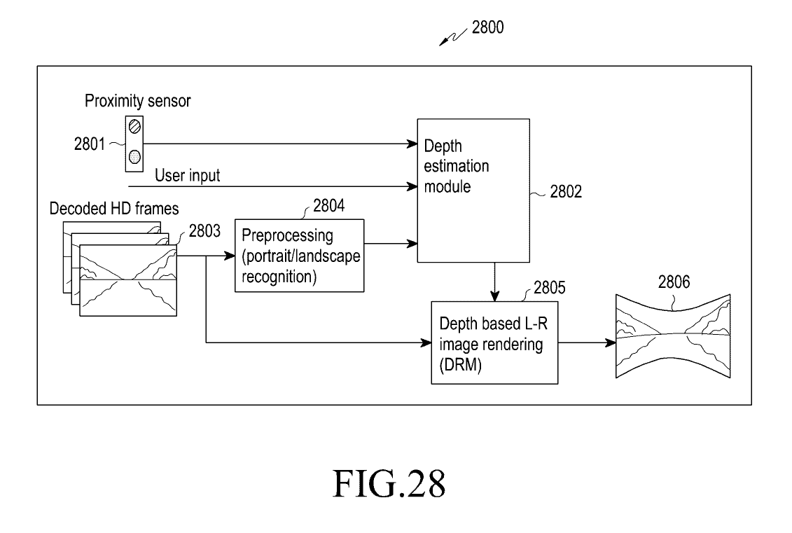

FIG. 28 illustrates the block diagram 2800 of the system according to the proposed invention. A proximity sensor 2801 senses the position and/or distance of one or more viewers and provides the same to a depth estimation module 2802, which can also receive user input(s), if any. At the same time decoded HD frames 2803 are provided to a pre-processing module 2804, which can interact with the depth estimation module 2802. Both the pre-processing module 2804 and the depth estimation module 2802, give their output to a depth based L-R image rendering (DRM) module 2805, which renders 3D content on a display screen 2806. The rendered content can be viewed through 3D glasses.

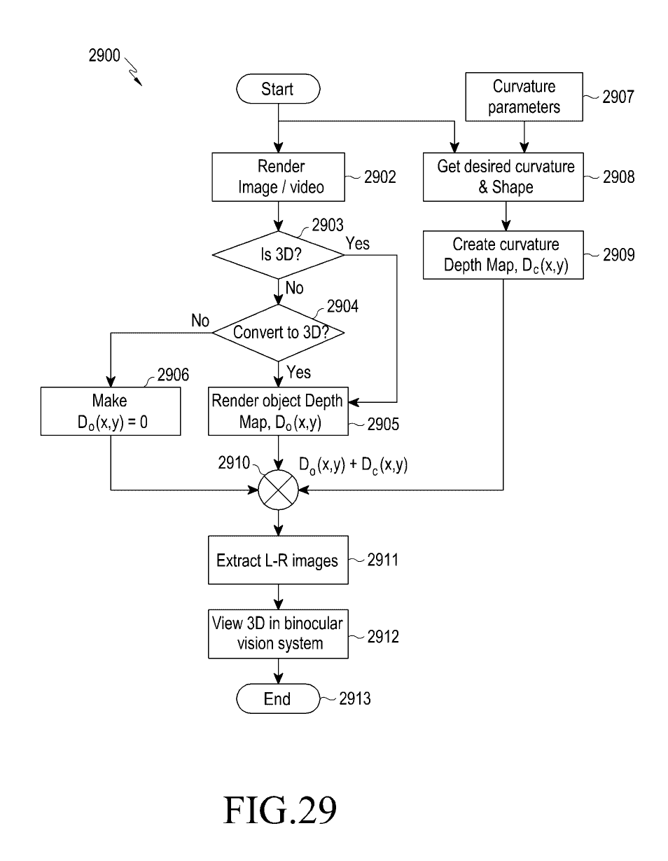

FIG. 29 illustrates a flow chart 2900 of the sequence of operations. At step 2901, the flow chart starts. At step 2902, image/video content rendering begins. At step 2903, it is checked whether the content is 3D. At step 2904, non 3D content may be converted into 3D. At step 2905, object depth map is rendered from the 3D content coming from step 2903 and 2904. In case of non 3D content, there is no need for any content depth map. In parallel, curvature parameters 2907 are used get desired virtual curvature and shape at step 2908. At step 2909, a corresponding curvature depth map is created. At step 2910, content depth map, if any, (only in case of 3D content) is added to this curvature depth map. After that L-R stereoscopic images are extracted at step 2911. At step 2912, the extracted L-R stereoscopic images can be viewed through any binocular vision system known in the art. The flow chart ends at step 2913.

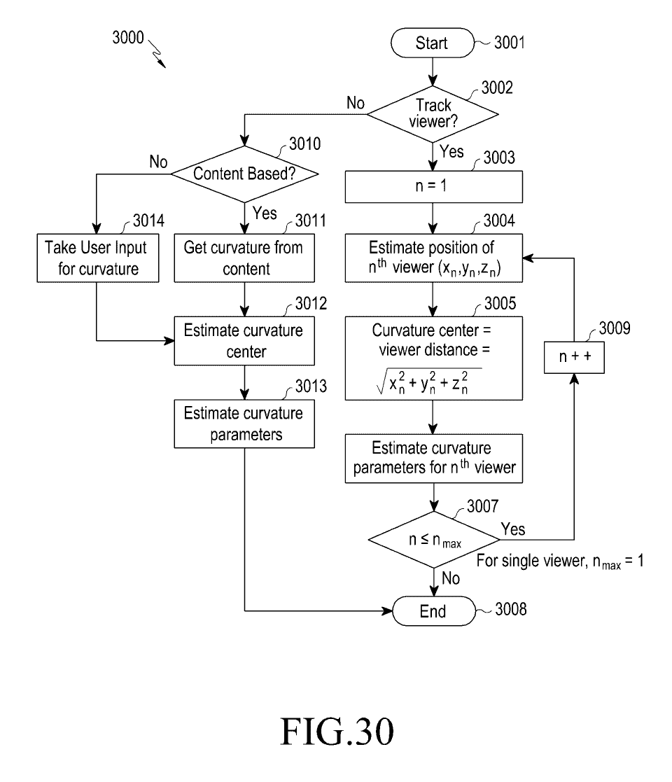

FIG. 30 illustrates a flow chart 3000 to estimate curvature parameters. At step 3001, the flow chart starts. At step 3002, a viewer is tracked. If viewer is trackable, then n is set as ‘1’ at step 3003. At step 3004, position of n^{th} viewer is estimated. At step 3005, curvature centre and viewer distance are computed. At step 3006, curvature parameters are estimated. At step 3007, it is checked of n is less than equal to nₘₐₓ. If yes, then n is incremented at step 3009 and flow goes back to step 3004. If no, the flow chart ends at step 3008. In case the when track-viewer feature is disabled, at step 3002, then requirement for content based curvature are taken into account at step 3010. If the curvature is to be based on content, then the curvature is determined based on the content at step 3011. At step 3012, the curvature centre is estimated, while the curvature parameters are estimated at step 3013 and then the flow chart ends at step 3008. However, if the curvature is not to be based on the content, then an input in relation to curvature is obtained from a user at step 3014 and then steps 3012 to 3013 may be performed.

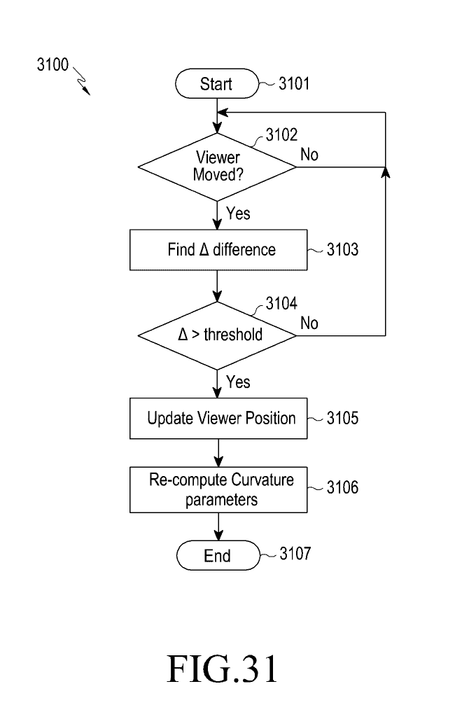

FIG. 31 illustrates a flow chart 3100 for user motion. The flow chart starts at step 3101. At step 3102, it is checked whether a viewer has moved. If yes, then the change in distance is computed at step 3103. At step 3104, it is checked whether the change in distance is greater than a threshold value. If yes, then new position of the viewer is updated at step 3105 and curvature parameters are re-computed at step 3106. The flow chart accordingly ends at step 3107.

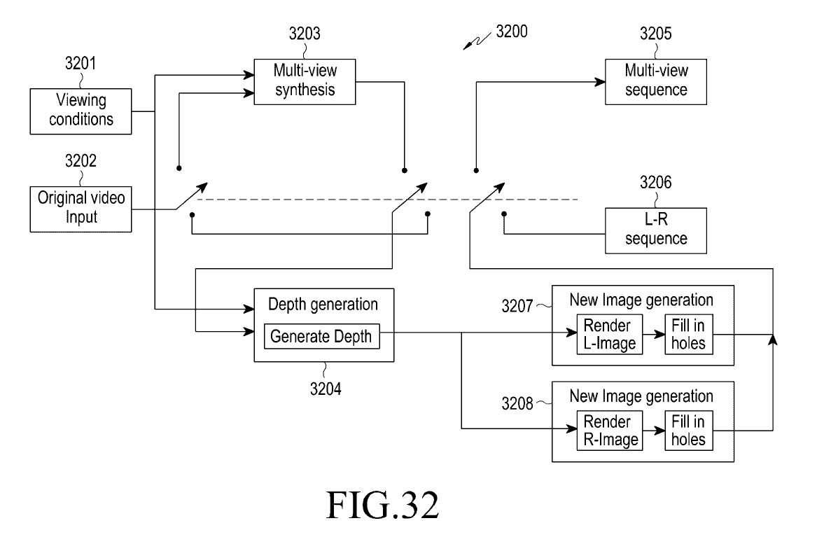

FIG. 32 illustrates a structure diagram 3200 to generate L-R image sequences for curved multi-view. Block 3201 observes viewing conditions, while block 3202 provides original video feed. In case multi-view synthesis is required, the original video feed is provided to a multi-view synthesis module 3203 to generate a multi-view sequence 3205. In any case, the original view feed is given to a depth generation module 3204, which on the basis of observed viewing conditions generates a depth map and generates L-R stereoscopic images 3206 with help of new image generation modules 3207 and 3208 for left and right image processing respectively. The module 3207 renders L-image and fills holes, if any. Similarly module 3208 renders R-image and fills holes, if any.

Now, multi-view with stereoscopic 3D using projectors is being described. 3D in theatre screens is quite popular and attracts much audience. Though other technologies exist, theatre screens are predominantly realized with projectors. Using the present disclosure one can realize 3D with multi-view in projector based displays. In one implementation, viewers are given a choice to choose the curvature parameters. In another implementation, which may be particularly useful for theatre screens, the curvature and other parameters can be pre-fixed for all the audiences who see one of the multiple-views in the multi-view system. Consider a specific example of dual-view in a theatre screen; the screen may appear flat in view 1 and curved in view 2. Flatness and virtual curve can be shown on the same screen. Audiences, who prefer to see the content on a flat screen, can see so, and the rest can watch it in a curved screen with each getting a symmetric curve irrespective of centre of corner seats. In another example, there may be first curvature in view 1 and second curvature in view 2. In another example, there may be corrected view for corner seats, whereas centre seats will be viewing the cinema as is, and the viewers at the corners will get a corrected view through 3D glasses.

In said theatre based implementation, separate audio can be provided to individual users through headphones, which can be embedded to the multi-view glasses or connected to audio port near their seat. Alternatively, one can use audio spotlight or any directed audio technology to add sound to a specific area, and preserve the quiet outside the zone. Hence, by using two such beams, one can realize dual-view between, say, left and right part of the audience. Audio spot light is a focused beam of sound similar to light beams. It uses ultrasonic entry to create narrow beams of sound.

Stereoscopic 3D in projectors works the same way in which it does in other video displays. The projector displays the video content with double the frequency, and the synchronization signals can be sent to every active shutter glasses in the theatre. The shutters of the L-R glasses can be transparent/opaque or opaque/transparent according to the synchronization signals received. Hence, a stereoscopic effect can be created by the entire system. In contrast, multi-view in theatre screens can be realized by making both L-R glasses receive the same content for viewer 1 and different L-R for viewer 2. In a two channel multi-view, any other viewer sees one of what viewer 1 and viewer 2 sees. Hence, to realize current invention, 3D and multi-view can be clubbed by displaying the desired content at 4 times the original frequency as already shown in FIG. 6C, where the (4n+1) th image is shown to the Left eye of viewer 1, (4n+2) th image is shown to the Left eye of viewer 2, (4n+3) th image is shown to the Right eye of viewer 1, (4n+4) th image is shown to the Right eye of viewer 2, and so on.

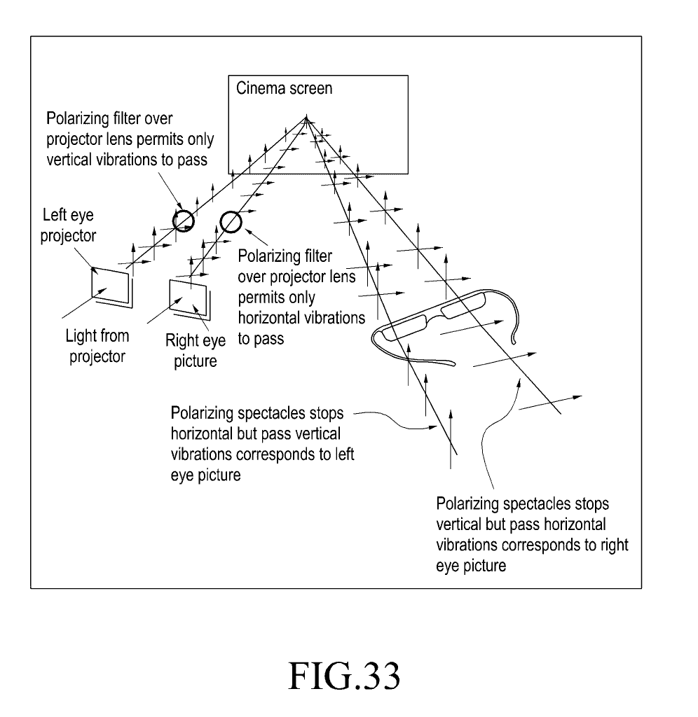

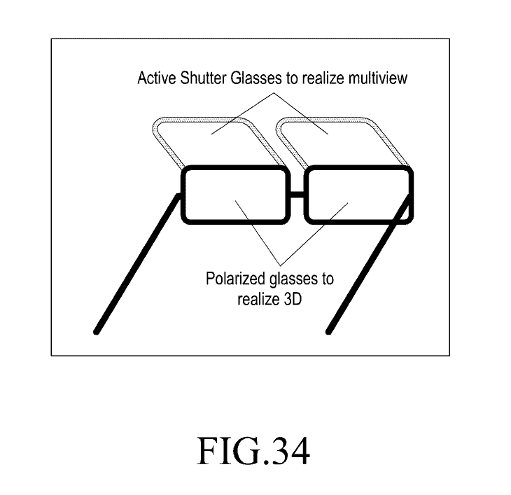

FIG. 33 depicts a passive shutter glasses based system to realize 3D in theatres. Accordingly, to realize the current invention, one can use a spatio-temporal arrangement to realize a multi-view technology with 3D technology, where multi-view effect will be created by one technology and 3D effect by the other, as depicted in FIG. 34.

While specific language has been used to describe the disclosure, any limitations arising on account of the same are not intended. As would be apparent to a person in the art, various working modifications may be made to the method in order to implement the inventive concept as taught herein. The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A method for displaying a stereoscopic image in a 3D display system, the method comprising:
generating at least one curvature depth map based on at least one virtual curvature value;
generating at least one pair of stereoscopic images from frames of at least one content based on the at least one curvature depth map; and
displaying or projecting the at least one pair of stereoscopic images on a display screen.

2. The method as claimed in claim 1, wherein the at least one content comprises one of at least one 2D content and at least one 3D content, and wherein if the at least one content comprises the at least one 3D content, the at least one pair of stereoscopic images is generated based on the at least one curvature depth map and a content depth map of the at least one 3D content.

3. The method as claimed in claim 1, wherein generating the at least one pair of stereoscopic images comprises generating the at least one pair of stereoscopic images from frames of at least one content based on a spatial or temporal multi-view arrangement.

4. The method as claimed in claim 1, further comprising:
determining, based on one or more parameters, the at least one virtual curvature value for each viewer device or each group of viewer devices individually, and
wherein the one or more parameters comprise at least one of a frame category, a frame resolution, a frame aspect ratio, a frame colour tone, metadata of a frame, a position of a viewer device, a distance between the viewer device and the display screen, a movement of the viewer device, a viewer's preference, screen dimensions, and a viewing angle.

5. The method as claimed in claim 1, wherein the at least one virtual curvature value comprises a physical curvature value of the display screen related to one of horizontally cylindrical, vertically cylindrical, spherical, asymmetric, substantially flat.

6. The method as claimed in claim 1, further comprising:
receiving, as the at least one virtual curvature value, a user input pertaining to a degree and/or type of virtual curvature.

7. The method as claimed in claim 1, wherein the at least one virtual curvature value is updated based on at least one of a position of a viewer device, a distance between the viewer device and the display screen, and a movement direction of the viewer device.

8. The method as claimed in claim 7, further comprising: performing at least one of a hole-filling operation and an averaging operation for the at least one pair of stereoscopic images to deal with missing or overlapping pixels, before displaying or projecting the at least one pair of stereoscopic images on the display screen.

9. The method as claimed in claim 1, wherein the at least one pair of stereoscopic images is displayed or projected based on a virtual screen having a screen size different than a screen size of the display screen.

10. The method as claimed in claim 1, wherein the at least one curvature depth map is generated based on at least one virtual curvature value different than a physical curvature value of the display screen among the at least one virtual curvature value.

11. A 3D display apparatus comprising:
a display;
a depth generation module configured to generate at least one curvature depth map based on at least one virtual curvature value;
a stereoscopic image generation module configured to generate at least one pair of stereoscopic images from frames of at least one content based on the at least one curvature depth map; and
a controller configured to control the display to display the at least one pair of stereoscopic images on a display screen.

12. The 3D display apparatus as claimed in claim 11, wherein the at least one content comprises one of at least one 2D content and at least one 3D content, and wherein if the at least one content comprises the at least one 3D content, the at least one pair of stereoscopic images is generated based on the at least one curvature depth map and a content depth map of the at least one 3D content.

13. The 3D display apparatus as claimed in claim 11, further comprising:
a multi-view synthesis module configured to generate the at least one pair of stereoscopic images from frames of at least one content based on a spatial or temporal multi-view arrangement.

14. The 3D display apparatus as claimed in claim 11, wherein the controller is further configured to:
determine the at least one virtual curvature value for each viewer device or each group of viewer devices individually, based on one or more parameters, and
wherein the one or more parameters comprise at least one of a frame category, a frame resolution, a frame aspect ratio, a frame colour tone, metadata of a frame, a position of a viewer device, a distance between the viewer device and the display screen, a movement of the viewer device, a viewer's preference, screen dimensions, and a viewing angle.

15. The 3D display apparatus as claimed in claim 11, further comprising:
an interface unit configured to receive, as the at least one virtual curvature value, a user input pertaining to a degree and/or type of virtual curvature.

16. The 3D display apparatus as claimed in claim 11, wherein the at least one virtual curvature value is updated based on at least one of a position of a viewer device, a distance between the viewer device and the display screen, and a movement direction of the viewer device.

17. The 3D display apparatus as claimed in claim 16, wherein the stereoscopic image generation module is further configured to perform at least one of a hole-filling operation and an averaging operation for the at least one pair of stereoscopic images to which the at least one virtual curvature value is applied, to deal with missing or overlapping pixels, before displaying or projecting the at least one pair of stereoscopic images on the display screen according to control of the controller.

18. The 3D display apparatus as claimed in claim 11, wherein the at least one virtual curvature value comprises a physical curvature value of the display screen related to one of horizontally cylindrical, vertically cylindrical, spherical, asymmetric, substantially flat.

19. The 3D display apparatus as claimed in claim 11, wherein the controller is further configured to control the display to display at least one pair of stereoscopic images based on a virtual screen having a screen size different than a screen size of the display screen.

20. The 3D display apparatus as claimed in claim 11, wherein the at least one curvature depth map is generated based on at least one virtual curvature value different than a physical curvature value of the display screen among the at least one virtual curvature value.
